(19) United States
(12) Patent Application Publication
(10) Pub. No.: US 2005/0188089 A1
(43) Pub. Date: Aug. 25, 2005

(54) Managing reservations for resources

(76) Inventors: Walter D. Lichtenstein, Belmont, MA (US); David Agraz, Philadelphia, PA (US); Luis Rojas, El Granada, CA (US); John Ruttenberg, Waban, MA (US); Anders Skoe, Foster City, CA (US)

Correspondence Address: VIERRA MAGEN MARCUS HARMON & DENIRO LLP, 685 MARKET STREET, SUITE 540, SAN FRANCISCO, CA, 94105, US

(21) Appl. No.: 10/785,844

(22) Filed: Feb. 24, 2004

(51) Int. Cl. G06F 15/173

(52) U.S. Cl. 709/226

(57) ABSTRACT

A methodology and algorithm for managing resources from classes within a pool of resources to determine whether and what resources may be allocated upon a request for resources.

### CROSS-REFERENCE TO RELATED APPLICATIONS

This Application is related to the following Applications:

U.S. patent application Ser. No. 09/853,816, entitled “System and Method for Controlling Data Transfer Rates on a Network,” filed May 11, 2001;

U.S. Patent application Ser. No. 09/935,016, entitled “System and Method for Scheduling and Executing Data Transfers Over a Network,” filed Aug. 21, 2001;

U.S. patent application Ser. No. 09/852,464, entitled “System and Method for Automated and Optimized File Transfers Among Devices in a Network,” filed May 9, 2001;

U.S. patent application Ser. No. 10/356,709, entitled “Scheduling Data Transfers For Multiple Use Request,” Attorney Docket No. RADI-01000US0, filed Jan. 31, 2003;

U.S. patent application Ser. No. 10/356,714, entitled “Scheduling Data Transfers Using Virtual Nodes,” Attorney Docket No. RADI-01001US0, filed Jan. 31, 2003; and

U.S. patent application Ser. No. 10/390,569, entitled “Providing Background Delivery of Messages Over a Network,” Attorney Docket No. RADI-01002US0, filed Mar. 14, 2003.

Each of these related Applications is incorporated herein by reference in its entirety.

### BACKGROUND OF THE INVENTION

1. Field of the Invention

The present invention is directed to methodology for efficient transmission of digital information over network, and in particular to a methodology and algorithm for managing resources from a pool of resources to determine whether and what resources may be allocated upon a request for resources.

2. Description of the Related Art

The growing use of communications networks has created increased demands for access to network bandwidth. Network users want to transfer large volumes of data through communications networks for local use. Corporate records and documentation shared by employees in multiple geographic locations provide examples of such data. Entertainment media, such as a digital movie file, provides another example.

Networks and network servers have a finite amount of available resources. Resources as used in this context may refer to a variety of parameters, such as for example the amount of storage space on a network server, the amount of bandwidth available at data receivers, the amount of bandwidth available at data senders, and the amount of bandwidth available at intermediary network servers that carry data between senders and receivers. When a request for resources is made, such as for example a request for the bandwidth required to forward a certain size data file within a specified period of time, only simplistic resource availability checks have conventionally been performed. On some networks, the only check is whether a resource is being used or is it available. Other systems perform basic resource reservation protocols. That is, there is a static reservation of a particular resource. Such systems offer no flexibility, often reserving too much of a resource for a particular need and resulting in an inefficient use of resources.

A problem with conventional approaches to resource allocation is that they do not take into consideration the many network variables that come into play. These variables can include the acceptable window of delivery for requested data, bandwidth available at data receivers, bandwidth available at data senders, and bandwidth available at intermediary network resources that carry data between senders and receivers. Failing to consider these resources can result in an inefficient use of network bandwidth and servers, and can result in both bottlenecks and latent periods.

### SUMMARY OF THE INVENTION

The present invention, roughly described, pertains to a methodology and algorithm for managing resources from a pool of resources to determine whether and what resources may be allocated upon a request for resources.

In one embodiment of the present invention, a communications network includes nodes that schedule data transfers using network related variables. In one implementation, these variables include acceptable windows of delivery for requested data, bandwidth available at data receivers, bandwidth available at data senders, and bandwidth available at intermediary network resources.

Each node may employ a resource management algorithm for the management and allocation of resources to classes of data and information at the node. When a request comes in for the use of resources from a particular class or classes at a node, the resource management algorithm determines whether the requested resource is available based on the resources reserved for other classes. The amount of a resource available for use by a request is given by the total available resources minus the restrictions on the use of resources for that class. Thus, the algorithm used by the present invention determines the restrictions on the classes, individually and grouped together to determine whether a request for resources from a given class or classes may be granted.

As used herein, a class may be any defined parameter, descriptor, group or object which makes use of resources. In the contexts of computer networks and servers, most typically, these resources are bandwidth and/or storage space, but other network resources are possible. Moreover, the resource management algorithm according to the present invention may further be used in any number of contexts outside of computer networks to reserve resources and address requests for resources from different classes.

These and other objects and advantages of the present invention will appear more clearly from the following description in which the preferred embodiment of the invention has been set forth in conjunction with the drawings.

### BRIEF DESCRIPTION OF THE DRAWINGS

The drawings will now be described with reference to the figures, in which:

FIG. 1 is block diagram of a communications network in which embodiments of the present invention can be employed.

FIG. 2 is a block diagram representing a data transfer in accordance with one embodiment of the present invention.

FIG. 3 is a block diagram representing a data transfer to multiple nodes in accordance with one embodiment of the present invention.

FIG. 4 is a block diagram of network nodes operating as senders, intermediaries, and receivers in one implementation of the present invention.

FIGS. 5A-5D are block diagrams of different transfer module configuration employed in embodiments of the present invention.

FIG. 6 is a flowchart describing one embodiment of a process for servicing a data transfer request.

FIG. 7 is a flowchart describing one embodiment of a process for providing a soft rejection.

FIG. 8 is a flowchart describing one embodiment of a process for determining whether a data transfer request is serviceable.

FIG. 9 is a flowchart describing one embodiment of a process for servicing a scheduling request.

FIG. 10 is a block diagram of a scheduling module in one implementation of the present invention.

FIG. 11 is a flowchart describing the resource reservation algorithm according to the present invention.

FIG. 12 is a block diagram of an admission control module in one implementation of the present invention.

FIG. 13 is a flowchart describing one embodiment of a process for determining whether sufficient transmission resources exist.

FIG. 14 is a set of bandwidth graphs illustrating the difference between flow through scheduling and store-and-forward scheduling.

FIG. 15 is a set of bandwidth graphs illustrating one example of flow through scheduling for multiple end nodes in accordance with one embodiment of the present invention.

FIG. 16 is a flowchart describing one embodiment of a process for generating a composite bandwidth schedule.

FIG. 17 is a flowchart describing one embodiment of a process for setting composite bandwidth values.

FIG. 18 is a graph showing one example of an interval on data demand curves for a pair of nodes.

FIG. 19 is a flowchart describing one embodiment of a process for setting bandwidth values within an interval.

FIG. 20 is a graph showing a bandwidth curve that meets the data demand requirements for the interval shown in FIG. 18.

FIG. 21 is a graph showing another example of an interval of data demand curves for a pair of nodes.

FIG. 22 is a graph showing a bandwidth curve that meets the data demand requirements for the interval shown in FIG. 21.

FIG. 23 is a flowchart describing one embodiment of a process for determining whether sufficient transmission bandwidth exists.

FIG. 24 is a flowchart describing one embodiment of a process for generating a send bandwidth schedule.

FIG. 25 is a graph showing one example of a selected interval of constraint and scheduling request bandwidth schedules.

FIG. 26 is a flowchart describing one embodiment of a process for setting send bandwidth values within an interval.

FIG. 27 is a graph showing a send bandwidth schedule based on the scenario shown in FIG. 25.

FIG. 28 is a graph showing another example of a selected interval of constraint and scheduling request bandwidth schedules.

FIG. 29 is a graph showing a send bandwidth schedule based on the scenario shown in FIG. 28.

FIG. 30 is a flowchart describing an alternate embodiment of a process for determining whether a data transfer request is serviceable, using proxies.

FIG. 31 is a flowchart describing one embodiment of a process for selecting data sources, using proxies.

FIG. 32 is a flowchart describing an alternate embodiment of a process for servicing data transfer requests when preemption is allowed.

FIG. 33 is a flowchart describing one embodiment of a process for servicing data transfer requests in an environment that supports multiple priority levels.

FIG. 34 is a flowchart describing one embodiment of a process for tracking the use of allocated bandwidth.

FIG. 35 is a block diagram depicting exemplar components of a computing system that can be used in implementing the present invention.

### DETAILED DESCRIPTION

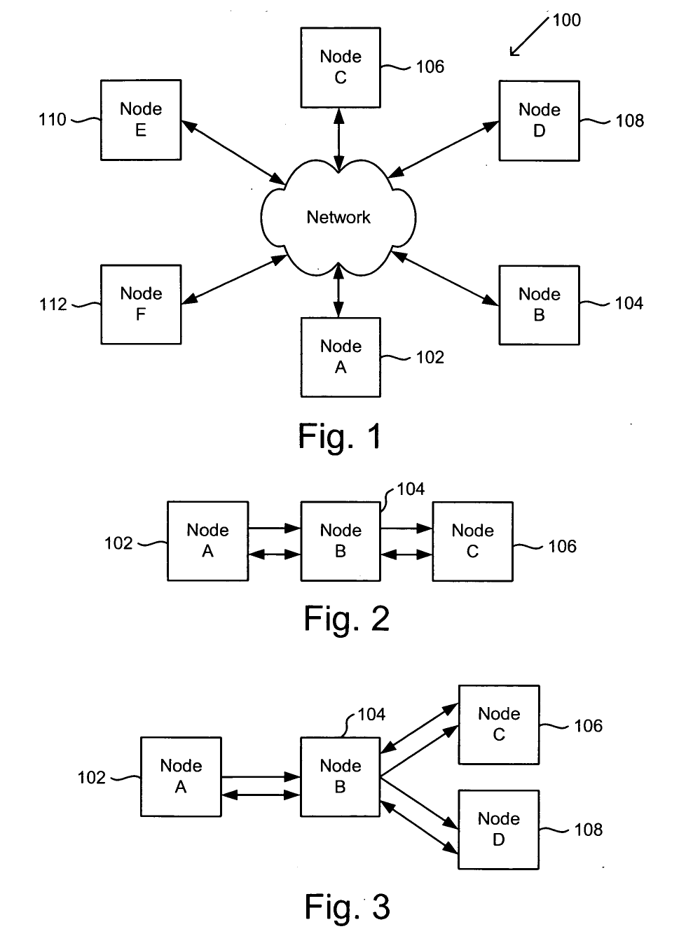

The present invention will now be described with reference to FIGS. 1 to 35, in embodiments relate to a methodology and algorithm for managing resources from a pool of resources to determine whether and what resources may be allocated upon a request for resources. It is understood that the present invention may be embodied in many different forms and should not be construed as being limited to the embodiments set forth herein. Rather these embodiments are provided so that this disclosure will be thorough and complete and will fully convey the invention to those skilled in the art. Indeed, the invention is intended to cover alternatives, modifications and equivalents of these embodiments, which are included within the scope and spirit of the invention as defined by the appended claims. Furthermore, in the following detailed description of the present invention, numerous specific details are set forth in order to provide a thorough understanding of the present invention. However, it will be clear to those of ordinary skill in the art that the present invention may be practiced without such specific details.

The present invention can be accomplished using hardware, software, or a combination of both hardware and software. The software used for the present invention may be stored on one or more processor readable storage media including hard disk drives, CD-ROMs, DVDs, optical disks, floppy disks, flash memories, tape drives, RAM, ROM or other suitable storage devices. In alternative embodiments, some or all of the software can be replaced by dedicated hardware including custom integrated circuits, gate arrays, FPGAs, PLDs, and special purpose computers.

FIG. 1 is block diagram of a communications network in which embodiments of the present invention can be employed. Communications network 100 facilitates communication between nodes A 102, B 104, C 106, D 108, E 110, and F 112. Network 100 can be a private local area network, a public network, such as the Internet, or any other type of network that provides for the transfer of data and/or other information. In further embodiments, network 100 can support more or less nodes than shown in FIG. 1, including implementations where substantially more nodes are supported.

FIG. 2 represents one example of a data transfer that takes place between nodes according to one embodiment of the present invention. Node A 102 is providing data to node C 106 via node B 104. The nodes employ a common scheme for scheduling data transfers from node A to node B and node B to node C. In one implementation, the common scheme considers the following factors when data transfers are serviced: bandwidth required for receiving data at a node, bandwidth required for sending data from a node, storage capacity for maintaining data at a node and reservations for bandwidth, storage capacity and other resources in accordance with the present invention. During the scheduling process, nodes A, B, and C share scheduling information, as shown by the bi-directional arrows. The single direction arrows represent the flow of data in this data transfer. Greater details regarding the algorithm for managing resources and regarding a process for scheduling data transfers are provided below. Nodes A, B and C are member nodes in that they all perform the same scheduling process. It is understood that one or more of the network nodes may perform different scheduling processes, making them non-member nodes. For such nodes, virtual nodes may be provided which have information allowing them to mirror the member node scheduling scheme at the non-member nodes. Embodiments including virtual nodes are explained in U.S. Patent application Ser. No. 10/356,714, entitled “Scheduling Data Transfers Using Virtual Nodes,” (Attorney Docket No. RADI-01001US0), previously incorporated by reference.

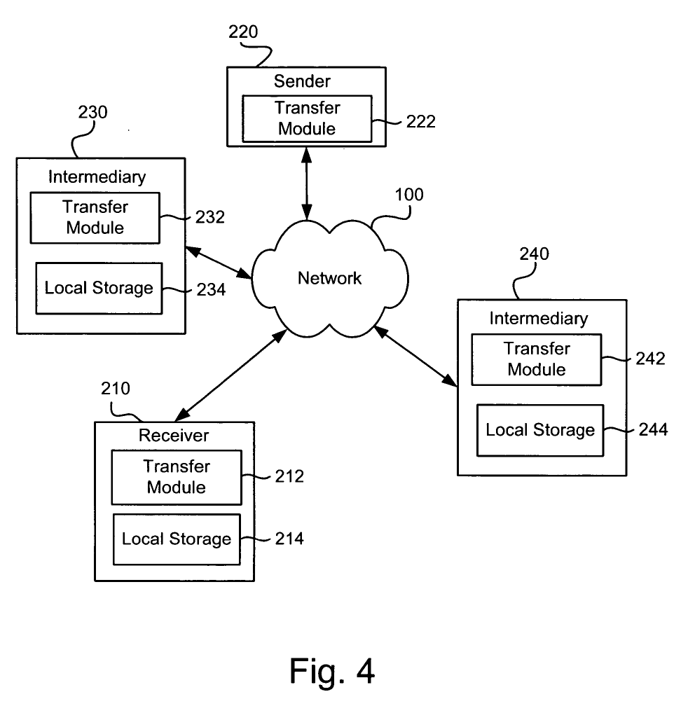

FIG. 4 is a block diagram of network nodes operating in different roles according to one embodiment of the present invention. Any node can receive data, send data, or act as an intermediary that passes data from one node to another. In fact, a node may be supporting all or some of these functions simultaneously.

Network 100 connects receiver node 210, sender node 220, and intermediary nodes 230 and 240. In this example, sender 220 is transferring data to receiver 210 through intermediaries 230 and 240. The data can include a variety of information such as text, graphics, video, and audio. Receiver 210 is a computing device, such as a personal computer, set-top box, or Internet appliance, and includes transfer module 212 and local storage 214. Sender 220 is a computing device, such as a web server or other appropriate electronic networking device, and includes transfer module 222. In further embodiments, sender 220 also includes local storage. Intermediaries 230 and 240 are computing devices, such as servers, and include transfer modules 232 and 242 and local storages 234 and 244, respectively.

Transfer modules 212, 222, 232, and 242 facilitate the scheduling of data transfers in accordance with the present invention. The transfer module at each node evaluates a data transfer request in view of satisfying various objectives as explained hereinafter. Example objectives include meeting a deadline for completion of the transfer, minimizing the cost of bandwidth, a combination of these two objectives, or any other appropriate objectives. In one embodiment, a transfer module evaluates a data transfer request using known and estimated bandwidths at each node, known and estimated storage space at receiver 210 and intermediaries 230 and 240, and the availability of such resources as dictated by a resource management algorithm explained below. A transfer module may also be responsive to a priority assigned to a data transfer.

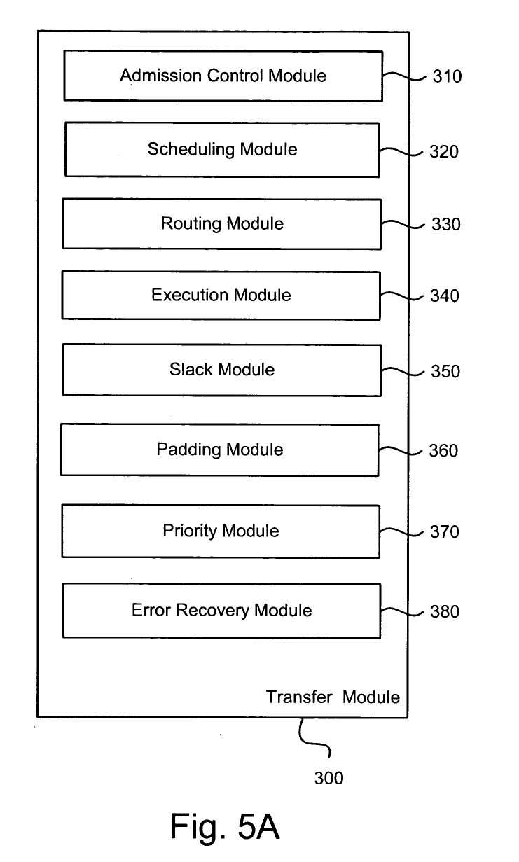

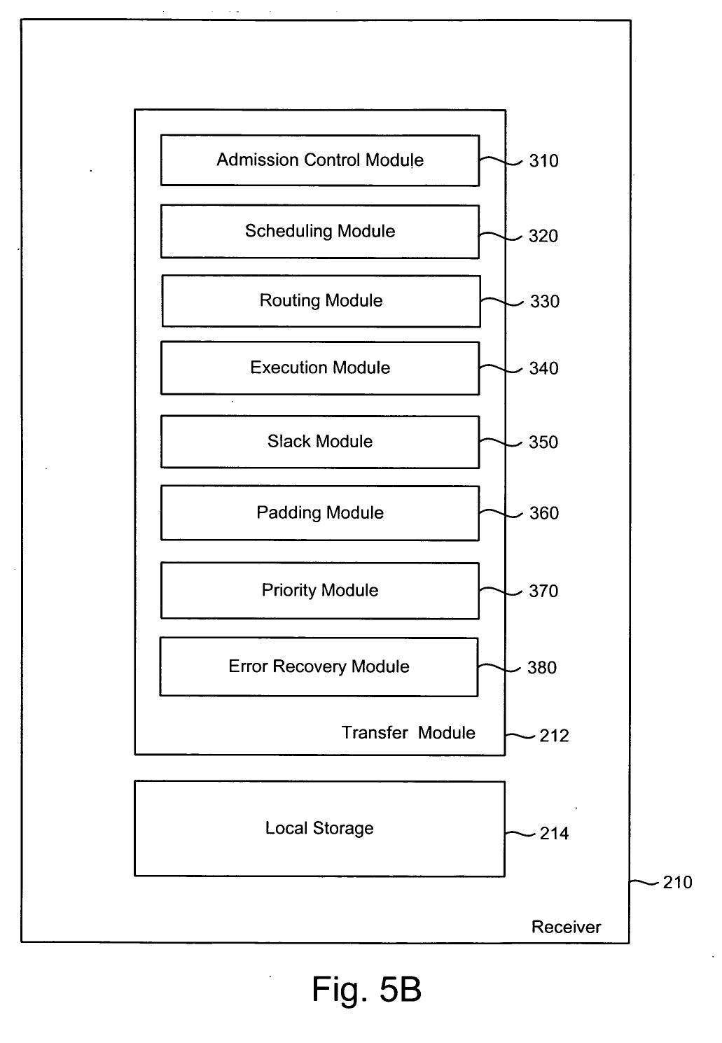

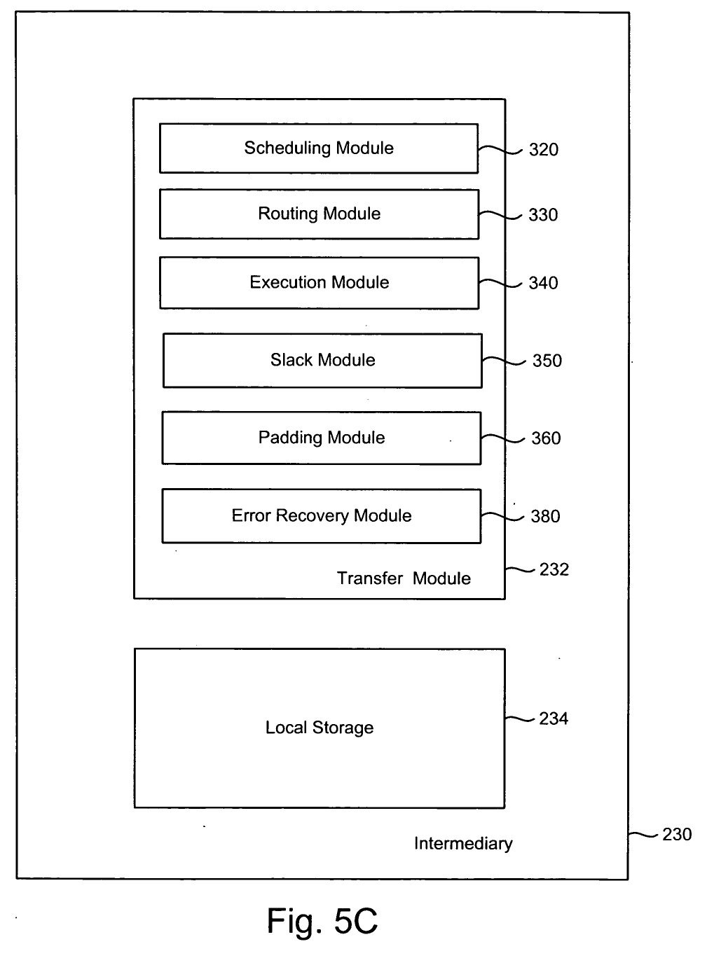

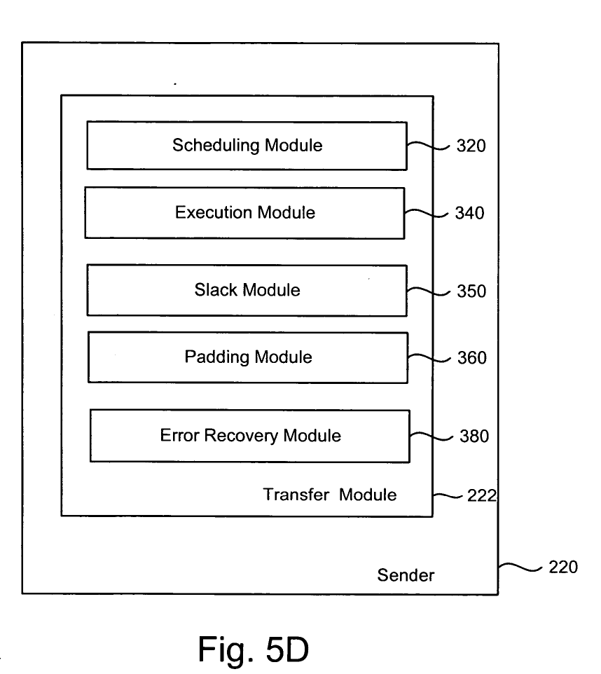

FIGS. 5A-5D are block diagrams of different transfer module configurations employed in embodiments of the present invention. FIG. 5A is a block diagram of one embodiment of a transfer module 300 that can be employed in a receiver, sender, or intermediary. Transfer module 300 includes, but is not limited to, admission control module 310, scheduling module 320, routing module 330, execution module 340, slack module 350, padding module 360, priority module 370, and error recovery module 380.

Admission control module 310 receives user requests for data transfers and determines the feasibility of the requested transfers in conjunction with scheduling module 320 and routing module 330. Admission control module 310 queries routing module 330 to identify possible sources of the requested data. Scheduling module 320 evaluates the feasibility of a transfer from the sources identified by routing module 330 and reports back to admission control module 310. This evaluation includes a determination of what resources are available for the transfer per the resource management algorithm explained hereinafter.

Execution module 340 manages accepted data transfers and works with other modules to compensate for unexpected events that occur during a data transfer. Execution module 340 operates under the guidance of scheduling module 320, but also responds to dynamic conditions that are not under the control of scheduling module 320.

Slack module 350 determines an amount of available resources that should be uncommitted in anticipation of differences between actual (measured) and estimated transmission times. Slack module 350 uses statistical estimates and historical performance data to perform this operation. Padding module 360 uses statistical models to determine how close to deadlines transfer module 300 should attempt to complete transfers. In alternative embodiments, the function of the slack module could be incorporated into the resource management algorithm according to the present invention, explained hereinafter. The slack could be implemented by defining a class with no members, and reserving resources for that class.

Priority module 370 determines which transfers should be allowed to preempt other transfers. In various implementations of the present invention, preemption is based on priorities given by users, deadlines, confidence of transfer time estimates, or other appropriate criteria. Error recovery module 380 assures that the operations controlled by transfer module 300 can be returned to a consistent state if an unanticipated event occurs.

Several of the above-described modules in transfer module 300 are optional in different applications. FIG. 5B is a block diagram of one embodiment of transfer module 212 in receiver 210. Transfer module 212 includes, but is not limited to, admission control module 310, scheduling module 320, routing module 330, execution module 340, slack module 350, padding module 360, priority module 370, and error recovery module 380. FIG. 5C is a block diagram of one embodiment of transfer module 232 in intermediary 230. Transfer module 232 includes scheduling module 320, routing module 330, execution module 340, slack module 350, padding module 360, and error recovery module 380. FIG. 5D is a block diagram of one embodiment of transfer module 222 in sender 220. Transfer module 22 includes scheduling module 320, execution module 340, slack module 350, padding module 360, and error recovery module 380.

It is understood that above-described transfer modules can have many different configurations in alternate embodiments. Also note that roles of the nodes operating as receiver 210, intermediary 230, and sender 220 can change—requiring their respective transfer modules to adapt their operation for supporting the roles of sender, receiver, and intermediary. For example, in one data transfer a specific computing device acts as intermediary 230 while in another data transfer the same device acts as sender 220.

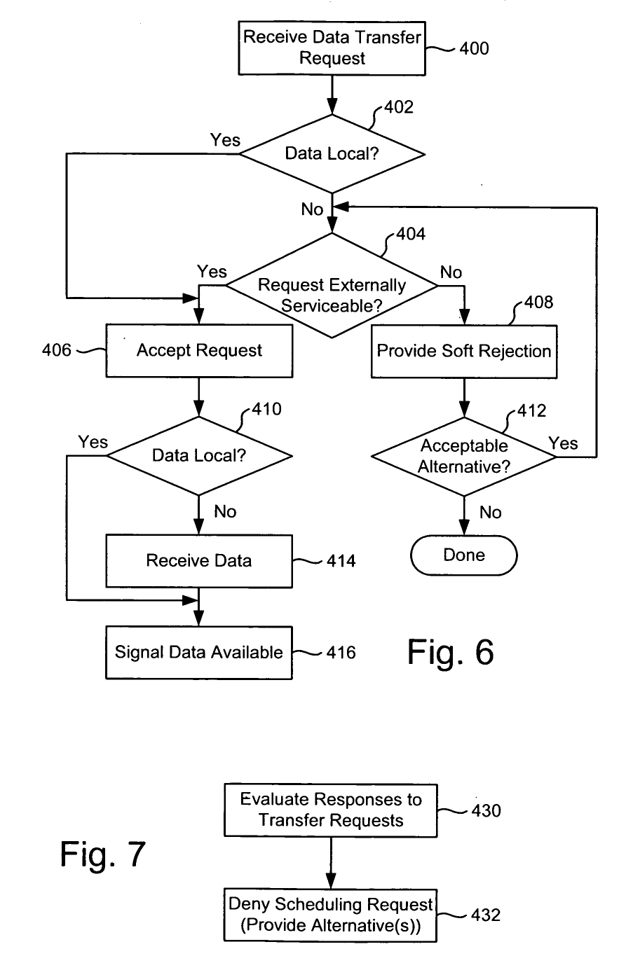

FIG. 6 is a flowchart describing one embodiment of a process employed by transfer module 300 to service user requests for data. Admission control module 310 receives a data transfer request from an end user (step 400) and determines whether the requested data is available in a local storage (step 402). If the data is maintained in the computer system containing transfer module 300, admission control module 310 informs the user that the request is accepted (406) and the data is available (step 416).

If the requested data is not stored locally (step 402), transfer module 300 determines whether the data request can be serviced externally by receiving a data transfer from another node in network 100 (step 404). If the request can be serviced, admission control module 310 accepts the user's data request (step 406). Since the data is not stored locally (step 410), the node containing transfer module 300 receives the data from an external source (step 414), namely the node in network 100 that indicated it would provide the requested data. The received data satisfies the data transfer request. Once the data is received, admission control module 310 signals the user that the data is available for use.

If the data request cannot be serviced externally (step 404), admission control module 310 provides the user with a soft rejection (408) in one embodiment. In one implementation, the soft rejection suggests a later deadline, higher priority, or a later submission time for the original request. A suggestion for a later deadline is optionally accompanied by an offer of waiting list status for the original deadline. Transfer module 300 determines whether the suggested alternative(s) in the soft rejection is acceptable. In one implementation, transfer module 300 queries the user. If the alternative(s) is acceptable, transfer module 300 once again determines whether the request can be externally serviced under the alternative condition(s) (step 404). Otherwise, the scheduling process is complete and the request will not be serviced. Alternate embodiments of the present invention do not provide for soft rejections.

FIG. 7 is a flowchart describing one embodiment of a process for providing a soft rejection (step 408). After transfer module 300 determines a request cannot be serviced (step 404), transfer module 300 evaluates the rejection responses from the external data sources (step 430). In one embodiment, these responses include soft rejection alternatives that admission control module 300 provides to the user along with a denial of the original data request (step 432). In alternate embodiments, admission control module 310 only provides the user with a subset of the proposed soft rejection alternatives, based on the evaluation of the responses (step 432).

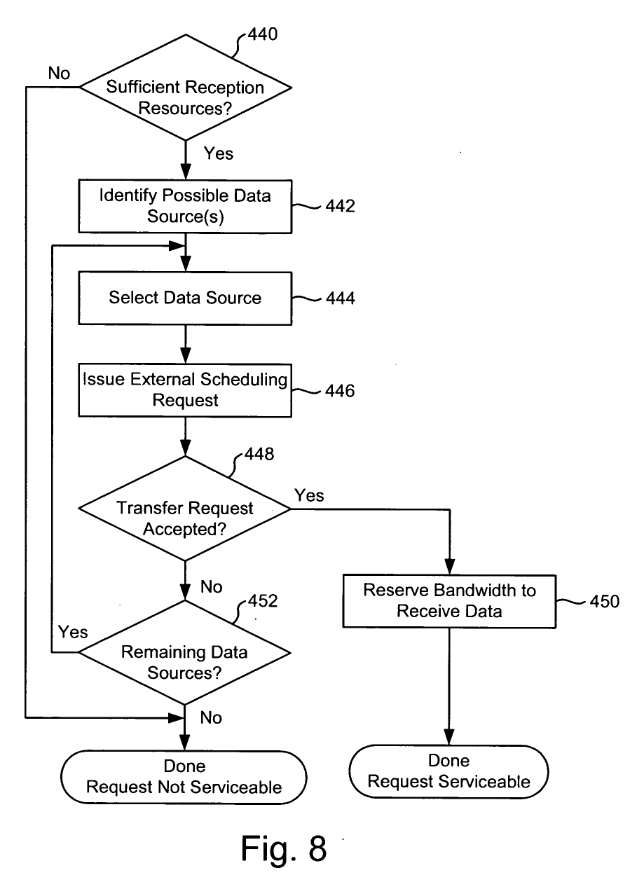

FIG. 8 is a flowchart describing one embodiment of a process for determining whether a data transfer request is serviceable (step 404, FIG. 6). Transfer module 300 determines whether the node requesting the data, referred to as the receiver, has sufficient resources for receiving the data (step 440) by applying the resource management algorithm (explained below). In one embodiment, this includes determining whether the receiver has sufficient data storage capacity and bandwidth for receiving the requested data (step 440). If the receiver's resources are insufficient, the determination is made that the request is not serviceable (step 440).

If the receiver has sufficient resources (step 440), routing module 330 identifies the potential data sources for sending the requested data to the receiver (step 442). In one embodiment, routing module 330 maintains a listing of potential data sources. Scheduling module 320 selects an identified data source (step 444) and sends the data source an external scheduling request for the requested data (step 446). In one implementation, the external scheduling request identifies the desired data and a deadline for receiving the data. In further implementations, the scheduling request also defines a required bandwidth schedule that must be satisfied by the data source when transmitting the data.

The data source replies to the scheduling request with an acceptance or a denial, again, in part based on the resource management algorithm. If the scheduling request is accepted, scheduling module 320 reserves bandwidth in the receiver for receiving the data (step 450) and informs admission control module 310 that the data request is serviceable.

If the scheduling request is denied, scheduling module 320 determines whether requests have not yet been sent to any of the potential data sources identified by routing module 330 (step452). If there are remaining data sources, scheduling module 320 selects a new data source (step 444) and sends the new data source an external scheduling request (step 446). Otherwise, scheduling module 320 informs admission control module 310 that the request is not serviceable.

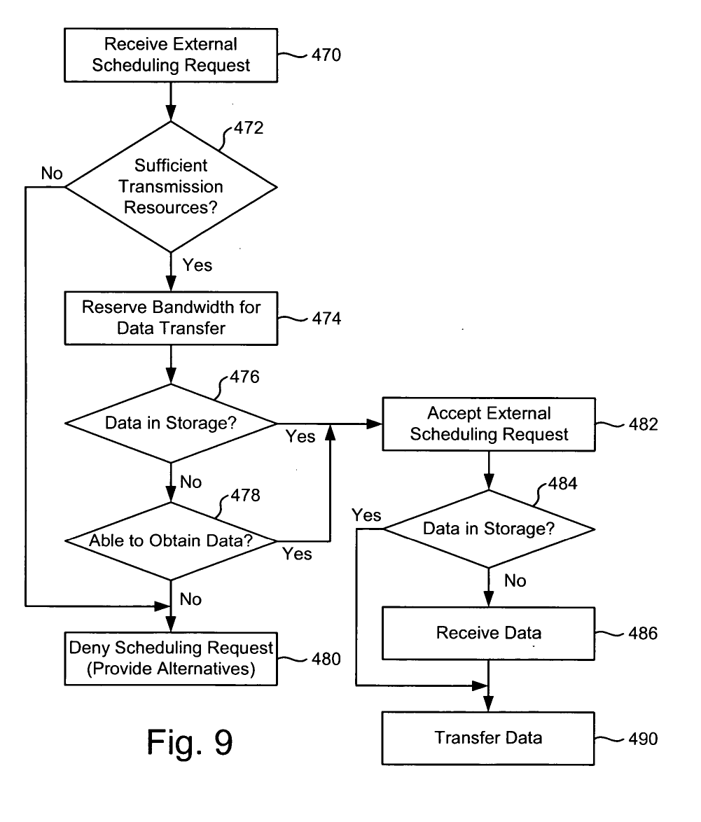

FIG. 9 is a flowchart describing one embodiment of a process for servicing an external scheduling request at a potential data source node, such as sender 220 or intermediary 230 (FIG. 4). Transfer module 300 in the data source receives the scheduling request (step 470). In the case of a virtual node, the data source is considered to be the combination of the virtual node and its associated non-member node. The virtual node receives the scheduling request (step 470), since the virtual node contains transfer module 300.

Transfer module 300 determines whether sufficient transmission resources are available for servicing the request (step 472). In one embodiment, scheduling module 300 in the data source determines whether sufficient bandwidth exists for transmitting the requested data (step 472). If the transmission resources are not sufficient, scheduling module 312 denies the scheduling request (step 480). In embodiments using soft rejections, scheduling module 320 also suggests alternative schedule criteria that could make the request serviceable, such as a later deadline.

If the transmission resources are sufficient (step 472) transfer module 300 reserves bandwidth at the data source for transmitting the requested data to the receiver (step 474). Transfer module 300 in the data source determines whether the requested data is stored locally (step 476). If the data is stored locally, transfer module 300 informs the receiver that the scheduling request has been accepted (step 482) and transfers the data to the receiver at the desired time (step 490).

If the requested data is not stored locally (step 476), scheduling module 320 in the data source determines whether the data can be obtained from another node (step 478). If the data cannot be obtained, the scheduling request is denied (step 480). Otherwise, transfer module 300 in the data source informs the receiver that the scheduling request is accepted. Since the data is not stored locally (step 484), the data source receives the data from another node (step 486) and transfers the data to the receiver at the desired time (step 490).

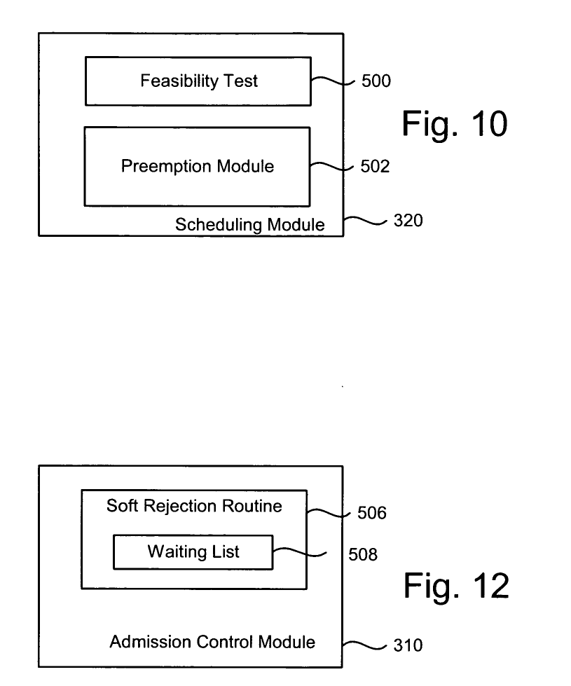

FIG. 10 is a block diagram of scheduling module 320 in one embodiment of the present invention. Scheduling module 320 includes a resource reservation module 500 and preemption module 502. Resource reservation module 500 determines whether sufficient transmission bandwidth is available in a sender or intermediary to service a scheduling request (step 472, FIG. 9). In one embodiment, resource reservation module 500 employs the resource management algorithm using the following information: the identities of sender 220 (or intermediary 230) and receiver 210, the size of the file to transfer, a maximum bandwidth receiver 210 can accept, a transmission deadline, and information about available and committed bandwidth resources. A basic function of resource reservation module 500 includes a comparison of the time remaining before the transfer deadline to the size of the file to transfer divided by the available bandwidth. This basic function is augmented by consideration of the total bandwidth that is already committed to other data transfers. Each of the other data transfers considered includes a file size and expected transfer rate used to calculate the amount of the total bandwidth their transfer will require.

Preemption module 502 is employed in embodiments of the invention that support multiple levels of priority for data requests. More details regarding preemption based on priority levels is provided below.

According to the present invention, the resource reservation module 500 employs a resource management algorithm to determine whether sufficient resources are available at a node (transmitting, intermediate and/or receiving) to satisfy a specific request. In general, the resource management algorithm allows for the reservation and allocation of resources for a class and/or combination of possibly overlapping classes within a pool of classes at each node.

When a request is made for resources at a node, the request will be from a class or classes. As used herein, a class may be any defined parameter, descriptor, group or object which makes use of resources. The class(es) are defined by the system administrator or user in a configuration file. The resources at a node are known and fixed. For example, the resources at a node may be available receive bandwidth, transmit bandwidth and available storage space. The classes which can be defined at each node may be different for each of these resources. As an illustrative example, with respect to available storage space to be allocated, an administrator may only be concerned with requests for a particular type of data, e.g., an mp3 file, or whether the file is bigger or smaller than 10 Mb. For receive bandwidth, the administrator may only care which other node the data is coming from, or who is asking for data. And there might be no reservations at all for transmit bandwidth.

When a request for resource comes into a node, the algorithm determines to which classes the request belongs and to which classes the request does not belong. This may be accomplished by implementing classes that are defined by an arbitrary logical OR of an arbitrary logical AND of properties that may be evaluated. Continuing with the illustrative example from the preceding paragraph, properties may be defined in classes as follows:
Name Equals $$$1
Name Has Substring Equals $$$2
Name Does Not Have Substring Equals $$$3
Size {equals, not equals, less than or equal, greater than or equal, greater than, less than} ###
Requestor Equals $$$4,
   where,
               $$$1 equals a first given string,
               $$$2 equals a second given string,
               $$$3 equals a third given string,
      ### equals a given size, and
               $$$4 equals a fourth given string.

Given this, a class may be defined as:
(Name Has Substring “mp3”) OR ((Name Does Not Have Substring “mp3”) AND (Size <10 Mb))

Once all relevant classes are defined, it may be determined to which class or classes a request for resources belongs.

The amount of a resource available for use by a request is given by the total available resources minus the restrictions on the use of resources for that class:
available_for_class=available_resources−restricted_for_class.

Thus, the algorithm used by the present invention determines the restrictions on the classes, individually and grouped together to determine whether a request for resources from a given class or classes may be granted.

In the contexts of computer networks and servers, most typically, these resources are bandwidth and/or storage space, but other network resources are possible, such as for example CPU usage, sockets and threads. As explained hereinafter, the resource management algorithm according to the present invention may further be used in any number of contexts outside of computer networks to reserve resources and address requests for resources from different classes.

Referring to FIG. 11, reservations in a particular class are arbitrarily set by a system administrator or user of a network node (step 800), based on the amount or percentage of resources that the administrator or user wishes to reserve for each class and/or combination of classes. The amount of resources reserved for a class may be selected based on statistical models of the historical resource usage information, or known requirements.

According to embodiments of the present invention, a pool at a node may have a number of classes, n, for which resources may be reserved. For all classes, n, in a pool of classes, there may be a total number of reservations equal to (2ⁿ)−1 for requests for resources in each class and/or combination of classes. In embodiments of the present invention, the reservations may be represented in an array, res, having (2ⁿ)−1 entries. Thus, for example, a pool at a node including 3 classes would have (2³)−1, or 7, reservations in the array res.

Each reservation, res[k] in the array may be assigned a portion of the resources by the administrator or user based on statistical and historical data. k is an integer such that the resources assigned to a given res[k] represent the portion of resources reserved for requests on the class or classes indicated by the binary expansion of k. That is, each k (base 10) may be represented by a binary number. Each bit in this binary number represents a separate class. The least significant bit, bit 0, represents Class 0, the next bit, bit 1, represents Class 1, . . . through the most significant, bit n-1, which represents Class n-1 (n-1 because the first class is Class 0). Thus, for a pool having 3 classes, there may be 7 reservations, each having a binary expansion with bits representing the respective classes as shown in the following table 1:

TABLE 1

| | Class: | | |
|---|---|---|---|
| | Class 2 | Class 1 | Class 0 |
| res[k]: | | | |
| res[1] | 0 | 0 | 1 |
| res[2] | 0 | 1 | 0 |
| res[3] | 0 | 1 | 1 |
| res[4] | 1 | 0 | 0 |
| res[5] | 1 | 0 | 1 |
| res[6] | 1 | 1 | 0 |
| res[7] | 1 | 1 | 1 |

It is understood that there may be more or less classes in alternative embodiments.

Given the above convention, where k is an integer having non-zero bits i₁, i₂, . . . , iₘ in the binary expansion of k, then res[k] may represent the resources reserved for requests in corresponding Classes i₁, i₂, . . . , iₘ. This may be seen by the following examples.

As shown by the shaded portions in the table 2 that follows, for a pool having 3 classes, res[4] represents the reservation for requests belonging to Class 2 (because bit 2 is the only non-zero bit in the binary expansion of 4). Similarly, res[5] represents the reservations for requests belonging to Class 0 and/or Class 2 (i.e. Class 0 (bit 0) and Class 2 (bit 2) are the only classes having a non-zero bit in the binary expansion of 5). And res[7] represents the reservations for requests belonging to Class 0, Class 1 and/or Class 2.

TABLE 2

| | Class: | | |
|---|---|---|---|
| | Class 2 | Class 1 | Class 0 |
| res[k]: | | | |
| res[1] | 0 | 0 | 1 |
| res[2] | 0 | 1 | 0 |
| res[3] | 0 | 1 | 1 |
| res[4] | 1 | 0 | 0 |
| res[5] | 1 | 0 | 1 |
| res[6] | 1 | 1 | 0 |
| res[7] | 1 | 1 | 1 |

Similarly, as can be seen from the shaded portions in the table 3 that follows, for a pool having 4 classes, it can be seen for example that res[2] represents the reservation for requests belonging to Class 1; res[3] represents the reservations for requests belonging to Class 0 and/or Class 1; res[12] represents the reservations for requests belonging to Class 2 and/or Class 3; and res[13] represents the reservations for requests belonging to Class 0, Class 2 and/or Class 3.

TABLE 3

Class:

| | Class 3 | Class 2 | Class 1 | Class 0 |
|---|---|---|---|---|
| res[1] | 0 | 0 | 0 | 1 |
| res[2] | 0 | 0 | 1 | 0 |
| res[3] | 0 | 0 | 1 | 1 |

.
.
.

| | | | | |
|---|---|---|---|---|
| res[12] | 1 | 1 | 0 | 0 |
| res[13] | 1 | 1 | 0 | 1 |
| res[14] | 1 | 1 | 1 | 0 |
| res[15] | 1 | 1 | 1 | 1 |

As indicated, the administrator may set the values for the reservations res[k] (Step 800, FIG. 11). These values may be set as a percentage, decimal number, integer or any value indicating some portion of all available resources that are being reserved in res[k]. As one example, in the above scenario having 4 classes, the following values may be applied to the reservations:
res[2]=res[12]=100
res[3]=200
res[13]=250.

Although integer numbers, these values are units that represent a percentage of the whole. Thus, in the above reservation values, the numbers are compared against 1000:100 equals 100/1000=10%; 200=200/1000=20%, etc. As stated above, a reservation res[k] represents the amount of available resources reserved in the classes indicated by the binary expansion of k. Thus, res[2] indicates that 10% of available resources are reserved for Class 1. Res[3] indicates that 20% of available resources are reserved for Classes 0 and 1 together. Res[12] indicates that 10% of available resources are reserved for Classes 2 and 3. And res[13] indicates that 25% of available resources are reserved for Classes 0, 2 and 3 together.

It is understood that instead of a numeric percentage of available resources, other units of measure may be used as assigned values for the reservation array res. Instead of percentages, reservation of explicit amounts of a resource may be made. For example, a user may reserve the maximum of 20% of total configured bandwidth or 100 Kbps between 9am and 5pm on weekdays. Reservations may be based on statistical analysis of historical data. Alternatively, reservations may be determined by business requirements. For example, a reservation may be to ensure that there is always enough bandwidth reserved to allow user to move 1 GB of data each night, because the user has paid for this capacity.

When a request for resources at a node is made (step 804, FIG. 11), the algorithm determines in a step 806 whether sufficient resources are available to satisfy the request. If not, the algorithm denies the request (step 830). Requests for resources are made from a particular class or classes. It may be a request belonging to a single class in the pool, or it may be a request belonging to a number of classes in the pool. As explained hereinafter, a node may also have more than one pool of classes, and a request may be made for resources in classes entirely outside of a pool of classes. As a request is processed, the algorithm determines the resources that will be required. In one embodiment, the algorithm determines the allocation of resources by first considering transmit bandwidth, then space, then receive bandwidth. For each resource, a set of classes is defined by a configuration file. Thus, as a first step in embodiments of the invention, the algorithm determines whether the request belongs to any of the transmit bandwidth classes, and if so, which ones. Once that is known, the restrictions on available transmit bandwidth for the current request can be computed, using the above formula:
available_for_class=available_resources−restricted_for_class.

The steps are repeated for the available space classes, the receive classes, and any other resource classes there may be.

Assuming a request for resources from a class or classes within a given pool, the restriction on that request may be determined based on the amount of resources reserved in the other classes. That is, when a request for resources comes into a node, the algorithm according to the present invention determines the restrictions on the request, i.e., whether sufficient resources are available given the reservations in the other classes to grant the request. If there are not sufficient resources, the request is denied.

The restriction on requests for resources in a particular class or classes will be determined by the amount of resources reserved in the remaining classes. If most of the resources are reserved in the other (unrequested) classes, the restriction on the request in the selected class(es) will be high. Conversely, if only a small amount of resources are reserved in the other classes, the restriction will be low.

As used herein, the restriction on a request belonging to one or more classes is denoted as:
restrictions],

where j=an integer between 0 and 2ⁿ−1 having a binary expansion with non-zero bits in the class(es) in which the request is made and zero bits in the classes in which the request is not made. Thus, referring for example to table 4 below, for the restriction[4], the integer 4 has a non-zero bit in i=2, or Class 2, in its binary expansion. Thus, the restriction[4] represents the restriction on a request belonging to Class 2. Similarly, for the restriction[5], the integer 5 has non-zero bits in i=0 and i=2, or Classes 0 and 2, in its binary expansion. Thus, the restriction[5] represents the restriction on a request in Classes 0 and 2.

TABLE 4

| | Class: | | |
|---|---|---|---|
| | Class 2 | Class 1 | Class 0 |
| res[1] | 0 | 0 | 1 |
| res[2] | 0 | 1 | 0 |
| res[3] | 0 | 1 | 1 |
| res[4] | 1 | 0 | 0 |
| res[5] | 1 | 0 | 1 |
| res[6] | 1 | 1 | 0 |
| res[7] | 1 | 1 | 1 |

Given this convention and the reservation array res described above, mathematically the restriction on a request belonging to one or more classes i₁, i₂, . . . , iₘ is the sum of res[k] over all k whose binary expansion has a 0 in each of corresponding bits i₁, i₂, . . . , iₘ (Class i₁ corresponding to bit i₁, Class i₂ corresponding to bit i₂, . . . , Class iₘ corresponding to bit iₘ):

$$restriction [ j ] = {\sum }_{k = 1}^{( 2 \hat{} n ) - 1} res [ k ]$$

for all k whose binary expansion has a 0 in bit i₁, i₂, . . . iₘ.

With this formula, for a pool having for example three classes, the restriction on all possible requests on classes in the pool and outside of the pool may be computed (step 802, FIG. 11):

$$\text{restriction[1]} = \text{restriction on a request in Class 0} \\ = res [ 2 ] + res [ 4 ] + res [ 6 ]$$

$$\text{restriction[2]} = \text{restriction on a request in Class 1} \\ = res [ 1 ] + res [ 4 ] + res [ 5 ]$$

$$\text{restriction[4]} = \text{restriction on a request in Class 2} \\ = res [ 1 ] + res [ 2 ] + res [ 3 ]$$

$$\text{restriction[3]} = \text{restriction on a request in Classes 0 and 1} \\ = res [ 4 ]$$

$$\text{restriction[5]} = \text{restriction on a request in Classes 0 and 2} \\ = res [ 2 ]$$

$$\text{restriction[6]} = \text{restriction on a request in Classes 1 and 2} \\ = res [ 1 ]$$

$$\text{restriction[7]} = \text{restriction on a request in}$$

$$Classes 1 , 2 and 3 \\ = 0$$

With regard to the last restriction, restriction[7], this is the restriction on a request belonging to every class in the pool. As there are no classes in the pool to which this request does not belong, the restriction on this request due to the pool is zero. Conversely, the restriction on a request outside of the pool, i.e. belonging to no classes in the pool, may also be computed. The restriction on such a request will be the sum total of all reservations within the pool. Thus, keeping with the example of three classes, the restriction on a request belonging to no classes in the pool is given by:
restriction[0]=res[1]+res[2]+res[3]+res[4]+res[5]+res[6]+res[7]

The restriction on the requests in a pool having more or less classes may similarly be computed as a summation function of the reservations within the pool.

Referring to the following table 5, as an example in a pool having 4 classes, a request for resources in Classes 0 and 2 results in a restriction on that request given by:

$$\text{restriction} [ 5 ] = {\sum }_{k = 1}^{15} res [ k ]$$

for all k whose binary expansion has a 0 in bit i=0 and i=2:

TABLE 5

Class:

| | Class 3 | Class 2 | Class 1 | Class 0 |
|---|---|---|---|---|
| res[1] | 0 | 0 | 0 | 1 |
| res[2] | 0 | 0 | 1 | 0 |
| res[3] | 0 | 0 | 1 | 1 |
| res[4] | 0 | 1 | 0 | 0 |
| res[5] | 0 | 1 | 0 | 1 |
| res[6] | 0 | 1 | 1 | 0 |
| res[7] | 0 | 1 | 1 | 1 |
| res[8] | 1 | 0 | 0 | 0 |
| res[9] | 1 | 0 | 0 | 1 |
| res[10] | 1 | 0 | 1 | 0 |
| res[11] | 1 | 0 | 1 | 1 |
| res[12] | 1 | 1 | 0 | 0 |
| res[13] | 1 | 1 | 0 | 1 |
| res[14] | 1 | 1 | 1 | 0 |
| res[15] | 1 | 1 | 1 | 1 |

Thus, restriction[5]=res[2]+res[8]+res[10].

In the immediately preceding example having 4 classes, assume a scenario where the administrator assigned the following values to res[k]:
res[2]=50
res[8]=150
res[10]=250

In such an example, the request for resources in Classes 0 and 2 results in a restriction on the request of res[2]+res[8]+res[10]=450, or 45% of the available resources. This is amount of resources that are restricted, or unavailable, to satisfy the request due to their use in the other classes. Thus, if the request were for more than 55%, the request would be denied. It is understood that each of the assigned values given in the above examples may vary in alternative embodiments.

Some of the reservations in a group consisting of 2ⁿ−1 reservations represent the overlap or relation between other reservations. Thus, for example, in a conceptual situation, a node may contain 3 classes:
Class 0 is bandwidth reserved for all marketing data,
Class 1 is bandwidth reserved for all data coming in from Boston, and
Class 2 is bandwidth reserved for all research data.

In this example, an administrator may reserve 30% of all available bandwidth for res[1]—marketing data; 25% of all available bandwidth for res[2]—Boston data; 15% of all available bandwidth for res[4]—sales data.

However, in this example, the administrator knows from historical and/or statistical data that some of the marketing data is also data that comes from Boston, and therefore there is an overlap between Class 0 and Class 1. This is accounted for in res[3], which may be set to some arbitrary negative value, using historical and/or statistical data, to account for the degree of overlap. For example, res[3]=−10%. Thus:
res[1]=30
res[2]=25
res[3]=−10.

With this information, if a request comes in for bandwidth in Class 2—sales data—the restrictions on this request due to the reservations in Class 0 and Class 1 may be determined, as indicated by the shaded area of table 6:

$$\text{restriction} [ 4 ] = {\sum }_{k = 1}^{7} res [ k ]$$

for all k whose binary expansion has a 0 in bit i=2.

TABLE 6

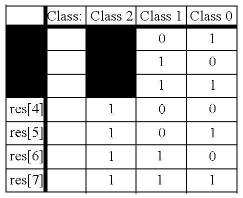

restriction[4]=res[1]+res[2]+res[3]
restriction[4]=30+25−10=45.

Thus, 45% of all resources would be unavailable for requests in Class 2. It is noted that this restriction is less than the sum of the reservations for the individual Classes 0 and 1. This is due to the ability of the algorithm of the present invention to account for the overlap between Classes 0 and 1, which is represented by the administrator in res[3]. Reservations for overlapping Classes may also be positive, for example in a situation where an administrator wishes to reserve greater resources for two or more groups than the sum of the reserved resources for those classes taken individually.

From the above discussion, in a pool including three classes, it can be seen that res[1] will represent the resources reserved solely for Class 0, res[2] will represent the resources reserved solely for Class 1, and res[4] will represent the resources reserved solely for Class 2. Res[3] will represent the overlap between Classes 0 and 1. Res[5] will represent the overlap between Classes 0 and 2. Res[6] will represent the overlap between Classes 1 and 2. And res[7] will represent the overlap between Classes 0, 1 and 2. It is understood that similar rules can be derived for pools having more or less classes.

Adding a class to a request may not increase the restriction on that request. That is, it cannot be harder to schedule a request for which more reservations are available. For example, R1 and R2 may be two requests made for resources from classes within a node, with R1 belonging to one more class that R2. For example, R1 might belong to Classes 0, 2, and 3, and R2 might belong to Classes 0 and 3. In this situation, the restriction on R2 must always be greater than or equal to the restriction on R1. This rule becomes significant when reallocating resources after a request for resources has been granted as explained hereinafter. The rule is also significant for determining which initial configurations are valid. If an administrator or user configures the reservations for a particular resource in such a way that they do not satisfy this rule, then the system will automatically modify the reservations to enforce the rule (as explained hereinafter).

If Class m represents the additional class in which R1 makes a request and R2 does not, then the request R1 is in classes i₁, i₂, . . . , iₘ, and R2 is in classes i₁, i₂, . . . , i₍ₘ₋₁₎. As indicated above, the restriction on R2 is the sum of res[k] over all k with bits i₁, . . . , i₍ₘ₋₁₎ all 0, and the restriction on R1 is the sum of res[k] over all k with bits i₁, . . . , i₍ₘ₋₁₎, iₘ all 0. Thus, the difference restriction[j] for request R1 −restriction[j] for request R2 is the sum of res[k] over all k with bits i₁, . . . , i₍ₘ₋₁₎ all 0 and bit iₘ=1. This sum must be greater than or equal to 0:
restriction[j] for R2−restriction[j] for

$$R1 = {\sum }_{k = 1}^{( 2 \hat{} n ) - 1} res [ k ]$$

for all k with bits i₁, i₂, . . . i₍ₘ₋₁₎₌0 and all bits iₘ=1;
restriction[j] for R2−restriction[j] for R1>=0.

For kₘₐₓ being the largest value of k in the sum over res[k], the minimum allowed value for res[kₘₐₓ] may be computed as a function of the values of res[k] for those ks with fewer 1-bits (non-zero bits) than kₘₐₓ. This may be seen by the following example with reference to table 7.

In a pool having four classes as shown in table 8:
restriction[2]-restriction[3]>=0
restriction[2]-restriction[6]>=0
restriction[2]-restriction[10]>=0

TABLE 7

Class:

| | Class 3 | Class 2 | Class 1 | Class 0 |
|---|---|---|---|---|
| res[1] | 0 | 0 | 0 | 1 |
| res[2] | 0 | 0 | 1 | 0 |
| res[3] | 0 | 0 | 1 | 1 |
| res[4] | 0 | 1 | 0 | 0 |
| res[5] | 0 | 1 | 0 | 1 |
| res[6] | 0 | 1 | 1 | 0 |
| res[7] | 0 | 1 | 1 | 1 |
| res[8] | 1 | 0 | 0 | 0 |
| res[9] | 1 | 0 | 0 | 1 |
| res[10] | 1 | 0 | 1 | 0 |
| res[11] | 1 | 0 | 1 | 1 |
| res[12] | 1 | 1 | 0 | 0 |
| res[13] | 1 | 1 | 0 | 1 |
| res[14] | 1 | 1 | 1 | 0 |
| res[15] | 1 | 1 | 1 | 1 |

The first difference—restriction[2]-restriction[3]—is shown shaded in table 8 using the above equation for determining the difference between two different restrictions. In the first difference, iₘ=0 corresponds to Class 0 (the additional class), and iₘ₋₁=1 corresponds to Class 1. Thus:
restriction[2]-restriction[3]=res[13]+res[9]+res[5]+res[1]>=0

Using the same equation for determining difference:
restriction[2]-restriction[6]=res[13]+res[12]+res[5]+res[4]>=0
restriction[2]-restriction[10]=res[13]+res[12]+res[9]+res[8]>=0

These equations may be solved for res[13] (which is res[kₘₐₓ]):
res[13]>=max(−(res[9]+res[5]+res[1]), −(res[12]+res[5]+res[4]), −(res[12]+res[9]+res[8]))

In most cases, this minimum value rule for res[kₘₐₓ] turns out to require an entry in res to be >= a non-positive value, but it may require an entry to be >= some positive value. For example, for n=3 classes, values of res[k] may be chosen as follows:
res[1]=res[2]=res[4]=110
res[3]=res[5]=res[6]=−75.
res[7]=?

The restriction[1] for requests in Class 0=res[2]+res[4]+res[6]=145. As indicated above, a request in fewer classes than Class 0 must be greater than or equal to the request in Class 0. A request that is in fewer classes than a single class must be outside of the pool (i.e., possibly belonging to other pools for the same resource). Therefore, the restriction on a request that is outside of the pool must be >= the restriction on the request in Class 0, or >=145. As is further indicated above, the restriction on a request outside the pool is given by the sum of res[k] over all k. Thus, a restriction on requests outside of the pool is given by:
res[1]+res[2]+res[3]+res[4]+res[5]+res[6]+res[7]>=145.

Substituting in the known values for res[1] through res[6]:
105+res[7]>=145
res[7]>=40.

Assuming a request for a reservation in one or more classes is made (step 804, FIG. 11), and is granted (step 806) after being subjected to the restriction rules set forth above, then the grant of the request will alter the available resources for that class and in the pool in general. Thus, the algorithm according to the present invention adjusts the reservations in the classes within the pool after a grant of resources according to the following rules.

In general, when a request for resources is made for a request in a class, the resources used are subtracted from the reservation for that class (step 808). The restrictions on all possible requests are then recomputed given the new reservations (step 810). The rule governing restrictions (stated above and described hereinafter) is then applied to the new restrictions (step 812). The restrictions are adjusted to the extent one or more of them violate the rules governing restrictions (step 814). If adjustment is necessary to a restriction, the minimum adjustment that will allow the restriction to conform to the rule is made. If a restriction was adjusted as having violated the rule, the reservations are then recomputed using the corrected restrictions (step 816).

When computing the new restrictions and determining whether adjustments to restrictions are required, the computations are made starting with the restrictions for indices with the most 1-bits. For example, for n=3, the rules are enforced by first applying them to the restriction[6], restriction[5], restriction[3] (those indices with two 1-bits). Next, the rules are enforced for restriction[4], restriction[2], restriction[1] (those indices with one 1-bit). Finally, the rules are enforced for restriction[0] (the only index with zero 1-bits).

The rule governing restrictions, stated above, is that adding a class to a request may not increase the restriction on that request. That is, it cannot be harder to schedule a request for which more reservations are available. Stated mathematically, the restriction on a request in Classes i₁, . . . , iₘ must be less than or equal to the restriction on a request in classes i₁, . . . , i₍ₘ₋₁₎. Thus, for n=3:
restriction[6]>=0
restriction[5]>=0
restriction[3]>=0
restriction[4]>=max(restriction[5], restriction[6])
restriction[2]>=max(restriction[3], restriction[6])
restriction[1]>=max(restriction[3], restriction[5])
restriction[0]>=max(restriction[1], restriction[2], restriction[4])

Table 8 illustrates an example. Assume a pool of three classes with the initial reservations as shown in the table:

TABLE 8

| | Class: | | |
|---|---|---|---|
| | Class 2 | Class 1 | Class 0 |
| res[1] = 100 | 0 | 0 | 1 |
| res[2] = 110 | 0 | 1 | 0 |
| res[3] = −30 | 0 | 1 | 1 |
| res[4] = 200 | 1 | 0 | 0 |
| res[5] = 150 | 1 | 0 | 1 |
| res[6] = 140 | 1 | 1 | 0 |
| res[7] = −50 | 1 | 1 | 1 |

The restrictions on requests may be computed as follows:
restriction[0]=res[1]+res[2]+res[3]+res[4]+res[5]+res[6]+res[7]=620
restriction[1]=res[2]+res[4]+res[6]=450
restriction[2]=res[1]+res[4]+res[5]=450
restriction[4]=res[1]+res[2]+res[3]=180
restriction[3]=res[4]=200
restriction[5]=res[2]=110
restriction[6]=res[1]=100
restriction[7]=0

First, the restrictions must be checked for adherence to the rule that a restriction in a number of classes i₁, . . . , iₘ must be less than or equal to a restriction in a number of classes i₁, . . . , i₍ₘ₋₁₎.

The restriction[0] in no classes in the pool=620. This is greater than each of the other restrictions for requests in at least one class. Therefore, restriction[0] satisfies the rule.

The restriction[1] in Class 0 (450) is greater than restriction[3] in Classes 0 and 1 (200) and is greater than the restriction[0] in Classes 0 and 2 (110). Therefore, restriction[1] satisfies the rule.

The restriction[2] in Class 1 (450) is greater than restriction[3] in Classes 0 and 1 (200) and is greater than the restriction[6] in Classes 1 and 2 (100). Therefore, restriction[2] satisfies the rule.

The restriction[4] in Class 2 (180) is greater than restriction[5] in Classes 0 and 2 (110) and is greater than the restriction[6] in Classes 1 and 2 (100). Therefore, restriction[4] satisfies the rule.

The restriction[3] in Classes 0 and 1 (200) is greater than restriction[7] in Classes 0, 1 and 2 (0). Therefore, restriction[3] satisfies the rule.

The restriction[5] in Classes 0 and 2 (110) is greater than restriction[7] in Classes 0, 1 and 2 (0). Therefore, restriction[5] satisfies the rule.

And finally, the restriction[6] in Classes 1 and 2 (100) is greater than restriction[7] in Classes 0, 1 and 2 (0). Therefore, restriction[6] satisfies the rule.

Therefore, each of the restrictions satisfies the rules governing restrictions.

Assume now that a request comes in for 30 units from Class 0. The restriction on a request in Class 0 is 450, or 45% of the resources unavailable. Therefore, as 55% of resources are available for requests in Class 0, a request for only 3% of the resources may be granted.

Next, res[1] for Class 0 is decreased the 30 units to reflect the grant. Res[1] now equals 100−30=70, as indicated in table 9:

TABLE 9

| | Class: | | |
|---|---|---|---|
| | Class 2 | Class 1 | Class 0 |
| res[1] = 70 | 0 | 0 | 1 |
| res[2] = 110 | 0 | 1 | 0 |
| res[3] = −30 | 0 | 1 | 1 |
| res[4] = 200 | 1 | 0 | 0 |
| res[5] = 150 | 1 | 0 | 1 |
| res[6] = 140 | 1 | 1 | 0 |
| res[7] = −50 | 1 | 1 | 1 |

After the modification of res[1], the restrictions are then again computed, and the new restrictions are checked for their conformity with the rule that a restriction in a number of classes i₁, . . . , iₘ must be less than or equal to a restriction in a number of classes i₁, . . . , i₍ₘ₋₁₎.
restriction[0]=res[1]+res[2]+res[3]+res[4]+res[5]+res[6]+res[7]=590
restriction[1]=res[2]+res[4]+res[6]=450
restriction[2]=res[1]+res[4]+res[5]=420
restriction[4]=res[1]+res[2]+res[3]=150
restriction[3]=res[4]=200
restriction[5]=res[2]=110
restriction[6]=res[1]=70
restriction[7]=0

The restriction[6] in Classes 1 and 2 (70) is greater than restriction[7] in Classes 0, 1 and 2 (0). Therefore, restriction[6] satisfies the rule.

The restriction[5] in Classes 0 and 2 (110) is greater than restriction[7] in Classes 0, 1 and 2 (0). Therefore, restriction[5] satisfies the rule.

The restriction[3] in Classes 0 and 1 (200) is greater than restriction[7] in Classes 0, 1 and 2 (0). Therefore, restriction[3] satisfies the rule.

The restriction[4] in Class 2 (150) is greater than restriction[5] in Classes 0 and 2 (110) and is greater than the restriction[6] in Classes 1 and 2 (70). Therefore, restriction[4] satisfies the rule.

The restriction[2] in Class 1 (420) is greater than restriction[3] in Classes 0 and 1 (200) and is greater than the restriction[6] in Classes 1 and 2 (70). Therefore, restriction[2] satisfies the rule.

The restriction[1] in Class 0 (450) is greater than restriction[3] in Classes 0 and 1 (200) and is greater than the restriction[5] in Classes 0 and 2 (110). Therefore, restriction[1] satisfies the rule.

And finally, the restriction[0] in no classes in the pool=590. This is greater than each of the other restrictions for requests in at least one other class. Therefore, restriction[0] satisfies the rule.

Therefore, each of the restrictions satisfies the rules governing restrictions and no further modification is necessary. The new reservations and restrictions after the grant satisfy the rules and are used by the algorithm for future requests for resources (step 818).

In an alternative example, assume the same initial values for res[k] before the grant as shown in table 7. However, instead of a request for 30 units from Class 0, the request is for 120 units from Class 0. Res[1] now equals 100−120=−20, as indicated in table 10:

TABLE 10

| | Class: | | |
|---|---|---|---|
| | Class 2 | Class 1 | Class 0 |
| res[1] = −20 | 0 | 0 | 1 |
| res[2] = 110 | 0 | 1 | 0 |
| res[3] = −30 | 0 | 1 | 1 |
| res[4] = 200 | 1 | 0 | 0 |
| res[5] = 150 | 1 | 0 | 1 |
| res[6] = 140 | 1 | 1 | 0 |
| res[7] = −50 | 1 | 1 | 1 |

After the modification of res[1], the restrictions are then again computed, and the new restrictions are checked for their conformity with the rule that a restriction in a number of classes i₁, . . . , iₘ must be less than or equal to a restriction in a number of classes i₁, . . . , i₍ₘ₋₁₎.
restriction[0]=res[1]+res[2]+res[3]+res[4]+res[5]+res[6]+res[7]=500
restriction[1]=res[2]+res[4]+res[6]=450
restriction[2]=res[1]+res[4]+res[5]=330
restriction[4]=res[1]+res[2]+res[3]=60
restriction[3]=res[4]=200
restriction[5]=res[2]=110
restriction[6]=res[1]=−20
restriction[7]=0

The computation begins with the restriction with indices with the most 1-bits and work backward. This first restriction is therefore restriction[6]. The restriction[6] in Classes 1 and 2 (−20) is not greater than or equal to restriction[7] in Classes 0, 1 and 2 (0). Therefore, restriction[6] needs to be adjusted to be greater than or equal to restriction[7]. The adjustment to restriction[6] is the minimum that will satisfy the rules. Therefore, restriction[6] is adjusted to be equal to restriction[7]. Restriction[6] is set to 0.

The restriction[5] in Classes 0 and 2 (110) is greater than restriction[7] in Classes 0, 1 and 2 (0). Therefore, restriction[5] satisfies the rule.

The restriction[3] in Classes 0 and 1 (200) is greater than restriction[7] in Classes 0, 1 and 2 (0). Therefore, restriction[3] satisfies the rule.

With regard to restriction[4] in Class 2, restriction[4] (60) is not greater than restriction[5] in Classes 0 and 2 (110) and is not greater than the restriction[6] in Classes 1 and 2 (70). Therefore, restriction[4] needs to be adjusted. The adjustment to restriction[4] is the minimum that will satisfy the rules. If restriction[4] was modified to 70, this would satisfy the requirement that it be greater than or equal to restriction[6], but it would not satisfy the requirement that it be greater than or equal to restriction[5]. Therefore, the algorithm according to the present invention sets restriction[4] to 110.

The restriction[2] in Class 1 (330) is greater than restriction[3] in Classes 0 and 1 (200) and is greater than the restriction[6] in Classes 1 and 2 (−20). Therefore, restriction[2] satisfies the rule.

The restriction[1] in Class 0 (450) is greater than restriction[3] in Classes 0 and 1 (200) and is greater than the restriction[5] in Classes 0 and 2 (110). Therefore, restriction[1] satisfies the rule.

And finally, the restriction[0] in no classes in the pool=500. This is greater than each of the other restrictions for requests in at least one other class. Therefore, restriction[0] satisfies the rule.

As one or more of the restrictions have been modified for not conforming to the rule, the newly modified restrictions must be used to go back and recomputed the reservations. The following are the equations for the restrictions given above:
restriction[0]=res1+res2+res4+res3+res5+res6+res7
restriction[1]=res2+res4+res6
restriction[2]=res1+res4+res5
restriction[4]=res1+res2+res3
restriction[3]=res4
restriction[5]=res2
restriction[6]=res1

Using an inclusion-exclusion process, these equations may be solved for res[k] in terms of restriction[j] starting from the last equation and working backwards:

$$res [ 1 ] = \text{restriction} [ 6 ] \\ res [ 2 ] = \text{restriction} [ 5 ] \\ res [ 4 ] = \text{restriction} [ 3 ] \\ res [ 3 ] = \text{restriction} [ 4 ] - res [ 1 ] - res [ 2 ] \\ = \text{restriction} [ 4 ] - \text{restriction} [ 6 ] - \text{restriction} [ 5 ] \\ res [ 5 ] = \text{restriction} [ 2 ] - res [ 1 ] - res [ 4 ] \\ = \text{restriction} [ 2 ] - \text{restriction} [ 6 ] - \text{restriction} [ 3 ] \\ res [ 6 ] = \text{restriction} [ 1 ] - res [ 2 ] - res [ 4 ] \\ = \text{restriction} [ 1 ] - \text{restriction} [ 5 ] - \text{restriction} [ 3 ] \\ res [ 7 ] = \text{restriction} [ 0 ] - ( res [ 1 ] + res [ 2 ] + res [ 4 ] ) - \\ res [ 3 ] - res [ 5 ] - res [ 6 ] \\ = \text{restriction} [ 0 ] - ( \text{restriction} [ 6 ] + \text{restriction} [ 5 ] + \\ \text{restriction} [ 3 ] ) - \\ ( \text{restriction} [ 4 ] - \text{restriction} [ 6 ] - \text{restriction} [ 5 ] ) - \\ ( \text{restriction} [ 2 ] - \text{restriction} [ 6 ] - \text{restriction} [ 3 ] ) - \\ ( \text{restriction} [ 1 ] - \text{restriction} [ 5 ] - \text{restriction} [ 3 ] ) \\ = \text{restriction} [ 0 ] - \text{restriction} [ 1 ] - \text{restriction} [ 2 ] - \\ \text{restriction} [ 4 ] + \text{restriction} [ 3 ] + \text{restriction} [ 5 ] + \\ \text{restriction} [ 6 ] .$$

Plugging in the adjusted values of restriction[j], the following final values of res[k] are obtained:
res[1]=0
res[2]=110
res[3]=0
res[4]=200
res[5]=130
res[6]=140
res[7]=−80

The result is that while the request was granted, res[1] could not be reduced by 120. After the grant of 120 units to satisfy the request, under the algorithm of the present invention, res[1] is reduced by 100 to 0, and res[5] is reduced by 20 to 130. In so doing, res[3] is increased by 30 to 0 and res[7] is decreased by 30 to −80. While n=3 in the above example, it is understood that the same steps may be used for solving res[k] in terms of restriction[j] where n is greater or lesser than 3.

The algorithm according to the present invention handles the grant of resources in multiple classes in a related manner, using an additional iterative process referred to herein as the inclusion-exclusion process. In particular, where a grant for an amount, A, is made for a request belonging to several classes, the first step is to subtract A from the specific reservations for each of the classes of the request. Then, A is added to each pair of classes of the request (i.e., all reservations where two class bits are “1” and the remaining bits are “0”). Then, A is subtracted from each group of three classes of the request (i.e., all reservations where three class bits are “1” and the remaining bits are “0”). This process of adding A to and subtracting A from reservations is continued until all reservations with m class bits are “1” and remaining bits are 0.

The next step is to recompute the restrictions on all possible requests given the new reservations as described above, and the recomputed restrictions are adjusted to the extent one or more of them violates the rules governing restrictions as described above. If adjustment is necessary to a restriction, the minimum adjustment that will allow the restriction to conform to the rule is made. The reservations are then recomputed using the adjusted restrictions as described above.

As an example illustrated in table 11, for a pool consisting of n=4 classes, a grant of 100 units of resource for a request in Classes 0, 2 and 3 will result in the following:

TABLE 11

Class:

| | Class 3 | Class 2 | Class 1 | Class 0 |
|---|---|---|---|---|
| res[1] | 0 | 0 | 0 | 1 |
| res[2] | 0 | 0 | 1 | 0 |
| res[3] | 0 | 0 | 1 | 1 |
| res[4] | 0 | 1 | 0 | 0 |
| res[5] | 0 | 1 | 0 | 1 |
| res[6] | 0 | 1 | 1 | 0 |
| res[7] | 0 | 1 | 1 | 1 |
| res[8] | 1 | 0 | 0 | 0 |
| res[9] | 1 | 0 | 0 | 1 |
| res[10] | 1 | 0 | 1 | 0 |
| res[11] | 1 | 0 | 1 | 1 |
| res[12] | 1 | 1 | 0 | 0 |
| res[13] | 1 | 1 | 0 | 1 |
| res[14] | 1 | 1 | 1 | 0 |
| res[15] | 1 | 1 | 1 | 1 |

100 units are subtracted from res[1], res[4] and res[8] (which represent Classes 0, 2 and 3).
100 units are then added to res[5], res[9] and res[12] (i.e., all reservations where two class bits are “1” and the remaining bits are “0”).
100 units are then subtracted from res[13] (i.e., all reservations where m class bits are “1” and the remaining bits are “0”).

The restrictions are then recomputed and adjusted if necessary and the reservations are recomputed if the restrictions are adjusted.

Although the preceding paragraphs discuss how to handle the subtraction of resources from a class, it is understood that the same methodology may be applied to add resources to a class, in the event for example a grant is revoked by another node and the resources are returned.

It may further happen that an administrator or user wishes to add an n^{th} class to an already configured pool of n-1 classes. This may be accomplished under the algorithm applying the above-described methodologies.

The resource management algorithm according to the present invention has been described for allocating resources within classes of a pool. The algorithm may be extended in a hierarchy such that the resource management algorithm provides for reservations for a set of pools, called a family, and a set of families, called a config. The restriction on a request determined by the reservations in a family is the sum of the restrictions determined by each pool in the family. The restriction on a request determined by the reservations in a config is the max of the restrictions determined by each family in the config. This structure allows a user to configure essentially arbitrary ways of combining reservations.

In general, if there are a large number of classes, it would be convenient to the extent possible to break them up into a large number of pools, each with a fairly small number of classes. For example, if there are n=100 classes, but the only detailed combining information the administrator wants to specify is within 20 pools of 5 classes each. In this scenario, it would be necessary to provide arrays of size 25 to keep track of reservations and restrictions within each of the 20 pools, so the full complexity would be proportional to 20*2⁵=640. This is more complex than n=100, with the 100 classes each being in its own pool (which would require an array of the size 100*2¹=200). It is conversely less complex than n=100, with 1 pool of 100 classes (which would require an array of the size 2¹⁰⁰).

The resource management algorithm according to the present invention may be used to manage and allocate resources in scenarios outside of computer networks and servers. By way of a simple illustration, airlines allocate seats, airplanes, crews, and these allocations could be subject to reservations, for example blocks of seats could be reserved for particular groups of travelers. As a further example, a manufacturing process may allocate factory facilities for accomplishing certain tasks, and the managers may decide to reserve some resources for favorite customers even before they have submitted orders. In fact, the resource management algorithm according to the present invention may be used in any scenario in which various classes of requests compete for resources, and it is desired to allocate the resources among the classes and to manage requests on those resources from the different classes.

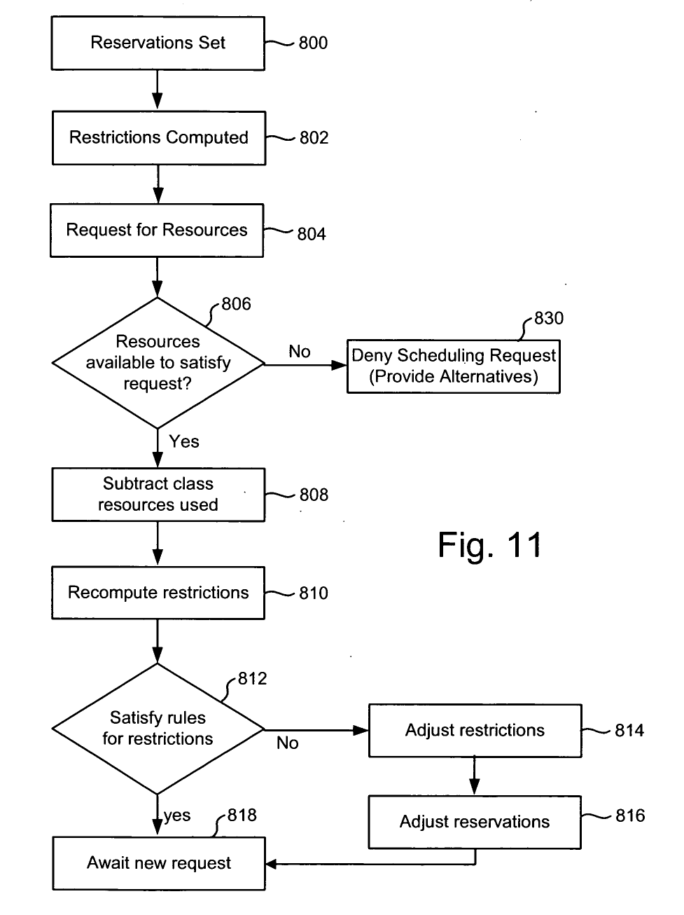

FIG. 12 is a block diagram of admission control module 310 in one implementation of the present invention. Admission control module 310 includes soft rejection routine module 506 to carry out the soft rejection operations explained above with reference to FIGS. 6 and 7. Admission control module 310 also includes waiting list 508 for tracking rejected requests that are waiting for bandwidth to become available.

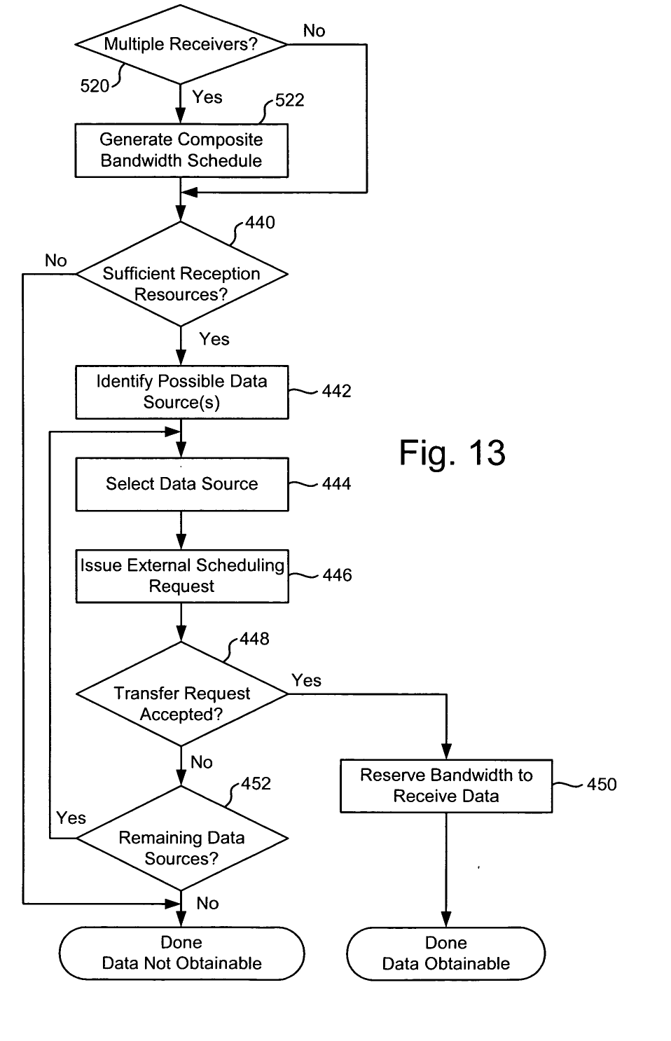

FIG. 13 is a flowchart describing one embodiment of a process for determining whether a node will be able to obtain data called for in a scheduling request (step 478, FIG. 6). The steps bearing the same numbers that appear in FIG. 8 operate the same as described above in FIG. 8 for determining whether data can be retrieved to satisfy a data request.

The difference arising in FIG. 13 is the addition of steps to address the situation where multiple nodes request the same data. As shown in FIG. 3, an intermediary, such as node B, may need to service multiple scheduling requests for the same data. The embodiment shown in FIG. 13 enables node B to issue a scheduling request that calls for a single data transfer from sender node A. The scheduling request calls for data that satisfies the send bandwidth schedules established by node B for transmitting data to nodes C and D (See FIG. 3).

Transfer module 300 in node B determines whether multiple nodes are calling for the delivery of the same data from node B (step 520, FIG. 13). If not, transfer module 300 skips to step 440 and carries out the process as described in FIG. 8. In this implementation, the scheduling request issued in step 446 is based on the bandwidth demand of a single node requesting data from node B.

If node B is attempting to satisfy multiple requests for the same data (step 520), scheduling module 310 in node B generates a composite bandwidth schedule (step 522). After the composite bandwidth schedule is generated, transfer module 300 moves to step 440 and carries on the process as described in FIG. 8. In this implementation, the scheduling request issued in step 446 calls for data that satisfies the composite bandwidth schedule.

The composite bandwidth schedule identifies the bandwidth demands a receiver or intermediary must meet when providing data to node B, so that node B can service multiple requests for the same data. Although FIG. 3 shows node B servicing two requests for the same data, further embodiments of the present invention are not limited to only servicing two requests. The principles for servicing two requests for the same data can be extended to any number of requests for the same data.

In one embodiment, node B issues a scheduling request for the composite bandwidth schedule before issuing any individual scheduling requests for the node C and node D bandwidth schedules. That request is handled by the methodology of the present invention as described herein to determine whether resources (bandwidth) are available to meet the request. In an alternate embodiment, node B generates a composite bandwidth schedule after a scheduling request has been issued for servicing an individual bandwidth schedule for node C or node D. In this case, transfer module 300 instructs the recipient of the individual bandwidth scheduling request that the request has been cancelled. Alternatively, transfer module 300 receives a response to the individual bandwidth scheduling request and instructs the responding node to free the allocated bandwidth. In yet another embodiment, the composite bandwidth is generated at a data source (sender or intermediary) in response to receiving multiple scheduling requests for the same data.

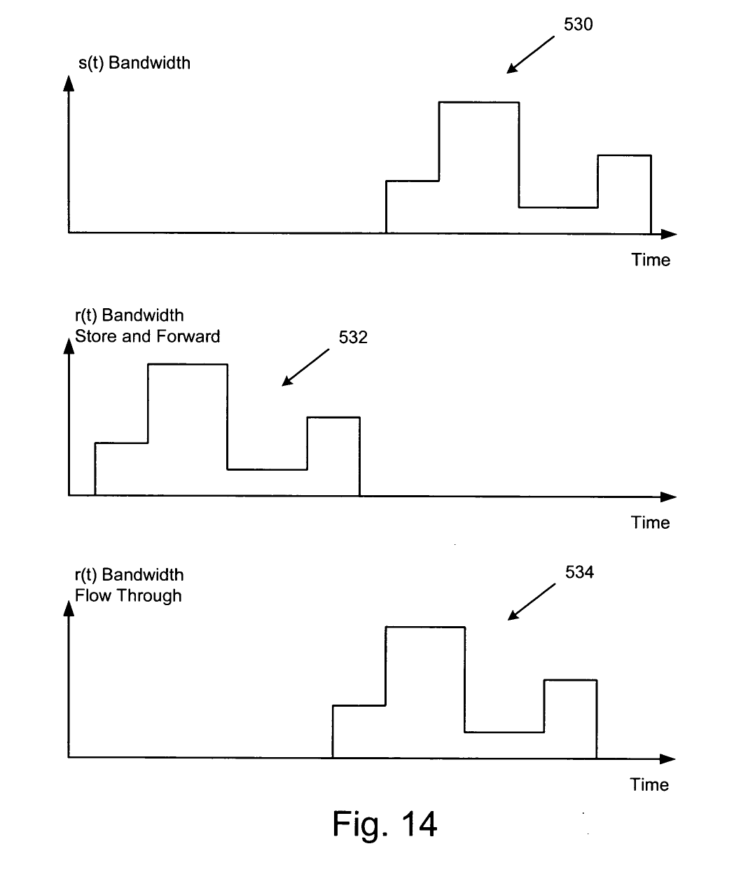

Data transfers can be scheduled as either “store-and-forward” or “flow through” transfers. FIG. 14 employs a set of bandwidth graphs to illustrate the difference between flow through scheduling and store-and-forward scheduling. In one embodiment, a scheduling request includes bandwidth schedule s(t) 530 to identify the bandwidth requirements a sender or intermediary must satisfy over a period of time. In one implementation, this schedule reflects the bandwidth schedule the node issuing the scheduling request will use to transmit the requested data to another node.

Bandwidth schedule r(t) 532 shows a store-and-forward response to the scheduling request associated with bandwidth schedule s(t) 530. In store-and-forward bandwidth schedule 532, all data is delivered to the receiver prior to the beginning of schedule 530. This allows the node that issued the scheduling request with schedule 530 to receive and store all of the data before forwarding it to another entity. In this embodiment, the scheduling request could alternatively identify a single point in time when all data must be received.

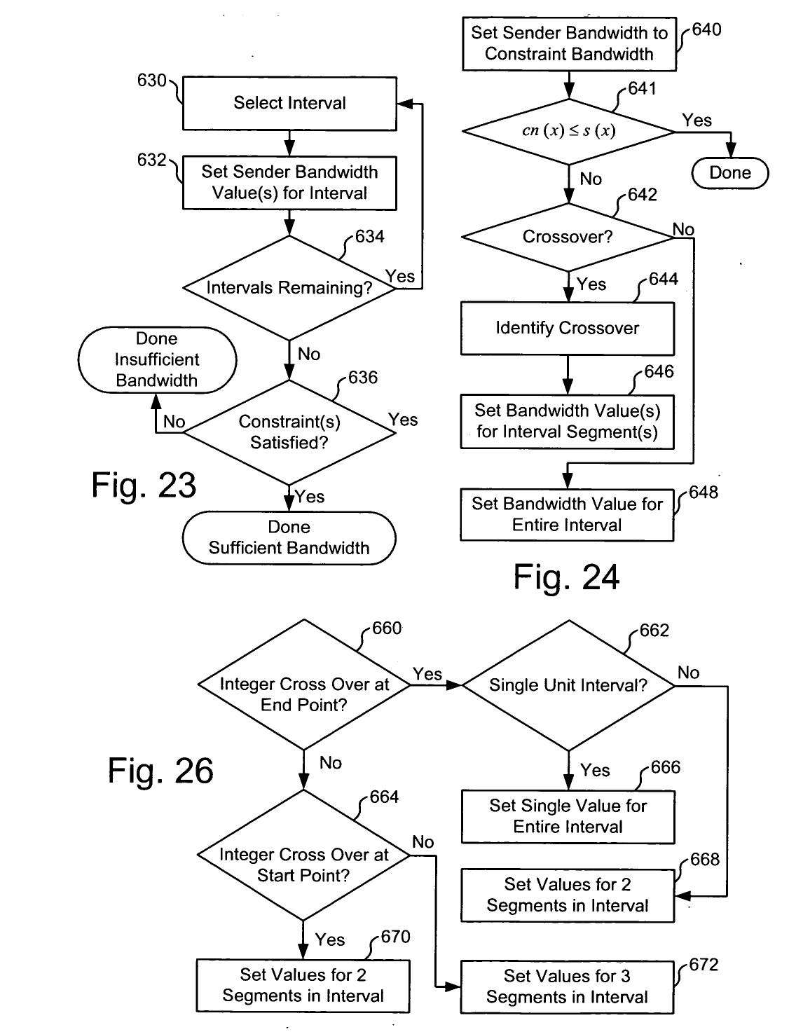

Bandwidth schedule r(t) 534 shows a flow through response to the scheduling request associated with bandwidth schedule s(t) 530. In flow through bandwidth schedule 534, all data is delivered to the receiver prior to the completion of schedule 530. Flow through schedule r(t) 534 must always provide a cumulative amount of data greater than or equal to the cumulative amount called for by schedule s(t) 530. This allows the node that issued the scheduling request with schedule s(t) 530 to begin forwarding data to another entity before the node receives all of the data. Greater details regarding the generation of flow through bandwidth schedule r(t) 534 are presented below with reference to FIGS. 23-25.

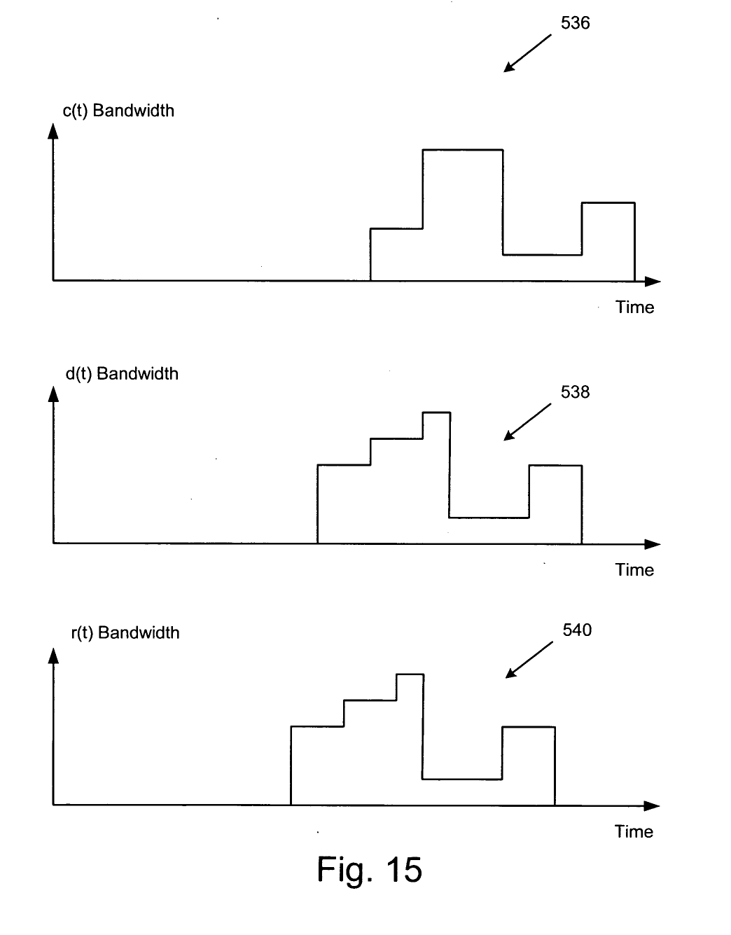

FIG. 15 is a set of bandwidth graphs illustrating one example of flow through scheduling for multiple end nodes in one embodiment of the present invention. Referring back to FIG. 3, bandwidth schedule c(t) represents a schedule node B set for delivering data to node C. Bandwidth schedule d(t) 536 represents a bandwidth schedule node B set for delivering the same data to node D. Bandwidth schedule r(t) 540 represents a flow through schedule node A set for delivering data to node B for servicing schedules c(t) 536 and d(t) 538. In one embodiment of the present invention, node A generates r(t) 540 in response to a composite bandwidth schedule based on schedules c(t) 536 and d(t) 538, as explained above in FIG. 13 (step 522). Although r(t) 540 has the same shape as d(t) 538 in FIG. 15, r(t) 540 may have a shape different than d(t) 538 and c(t) 536 in further examples.

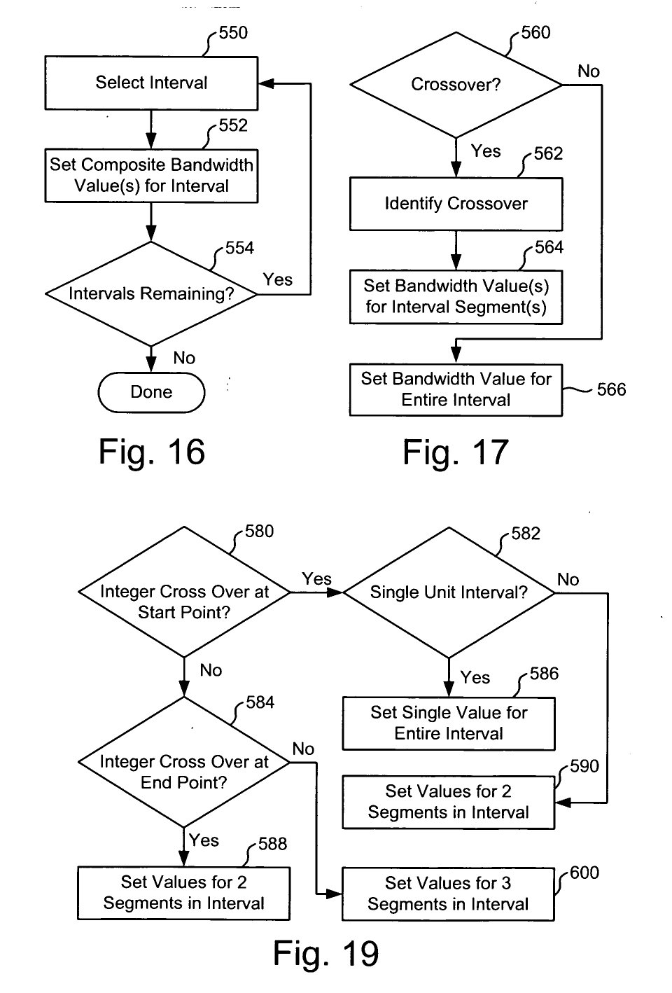

FIG. 16 is a flowchart describing one embodiment of a process for generating a composite bandwidth schedule (step 522, FIG. 13). In this embodiment, bandwidth schedules are generated as step functions. In alternate embodiments, bandwidth schedules can have different formats. Scheduling module 320 selects an interval of time (step 550). For each selected interval, each of the multiple bandwidth schedules for the same data, such as c(t) 536 and d(t) 538, have a constant value (step 550). Scheduling module 320 sets one or more values for the composite bandwidth schedule in the selected interval (step 552). Scheduling module 300 determines whether any intervals remain unselected (step 554). If any intervals remain unselected, scheduling module 320 selects a new interval (step 550) and determines one or more composite bandwidth values for the interval (step 552). Otherwise, the composite bandwidth schedule is complete.

FIG. 17 is a flowchart describing one embodiment of a process for setting composite bandwidth schedule values within an interval (step 552, FIG. 17). The process shown in FIG. 17 is based on servicing two bandwidth schedules, such as c(t) 536 and d(t) 538. In alternate embodiments, additional schedules can be serviced.

The process in FIG. 17 sets values for the composite bandwidth schedule according to the following constraint: the amount of cumulative data called for by the composite bandwidth schedule is never less than the largest amount of cumulative data required by any of the individual bandwidth schedules, such as c(t) 536 and d(t) 538. In one embodiment, the composite bandwidth schedule is generated so that the amount of cumulative data called for by the composite bandwidth schedule is equal to the largest amount of cumulative data required by any of the individual bandwidth schedules. This can be expressed as follows for servicing two individual bandwidth schedules, c(t) 536 and d(t) 538:

$$cb ( t ) = \frac{ⅆ}{ⅆ t} [ max ( C ( t ) , D ( t ) ) ]$$

Wherein:
cb(t) is the composite bandwidth schedule;
t is time;
max ( ) is a function yielding the maximum value in the parentheses;

$$C ( t ) = {\int }_{- ∞}^{t} c ( t ) ⅆ t$$
(representing the cumulative data demanded by bandwidth schedule c(t) 536); and

$$D ( t ) = {\int }_{- ∞}^{t} d ( t ) ⅆ t$$
(representing the cumulative data demanded by bandwidth schedule d(t) 538).

This relationship allows the composite bandwidth schedule cb(t) to correspond to the latest possible data delivery schedule that satisfies both c(t) 536 and d(t) 538.

At some points in time, C(t) may be larger than D(t). At other points in time, D(t) may be larger than C(t). In some instances, D(t) and C(t) may be equal. Scheduling module 320 determines whether there is a data demand crossover within the selected interval (step 560, FIG. 17). A data demand crossover occurs when C(t) and D(t) go from being unequal to being equal or from being equal to being unequal. When this occurs, the graphs of C(t) and D(t) cross at a time in the selected interval.

When a data demand crossover does not occur within a selected interval, scheduling module 320 sets the composite bandwidth schedule to a single value for the entire interval (step 566). If C(t) is larger than D(t) throughout the interval, scheduling module 320 sets the single composite bandwidth value equal to the bandwidth value of c(t) for the interval. If D(t) is larger than C(t) throughout the interval, scheduling module 320 sets the composite bandwidth value equal to the bandwidth value of d(t) for the interval. If C(t) and D(t) are equal throughout the interval, scheduling module 320 sets the composite bandwidth value to the bandwidth value of d(t) or c(t)—they will be equal under this condition.

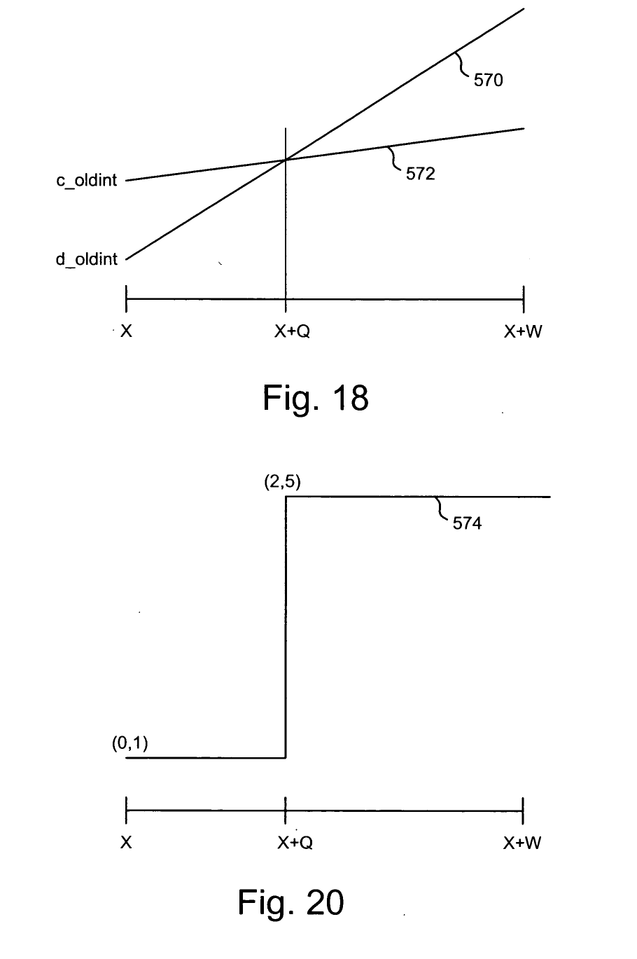

When a data demand crossover does occur within a selected interval, scheduling module 320 identifies the time in the interval when the crossover point of C(t) and D(t) occurs (step 562). FIG. 18 illustrates a data demand crossover point occurring within a selected interval spanning from time x to time x+w. Line 570 represents D(t) and line 572 represents C(t). In the selected interval, D(t) and C(t) cross at time x+Q, where Q is an integer. Alternatively, a crossover may occur at a non-integer point in time.

In one embodiment, scheduling module 320 identifies the time of the crossover point as follows:
Q=INT[(c_oldint−d_oldint)/(d(x)−c(x))]; and
RM=(c_oldint−d_oldint)−Q*(d(x)−c(x))
Wherein:
Q is the integer crossover point;
INT[ ] is a function equal to the integer portion of the value in the brackets;
RM is the remainder from the division that produced Q, where t=x+Q+(RM/(c_oldint−d_oldint)) is the crossing point of D(t) and C(t) within the selected interval;

$$c\_oldint = {\int }_{- ∞}^{x} c ( t ) ⅆ t$$
(representing the y-intercept value for line 572);

$$d\_oldint = {\int }_{- ∞}^{x} d ( t ) ⅆ t$$
(representing the y-intercept value for line 570);
x is the starting time of the selected interval;
w is the time period of the selected interval;
c(x) is the slope of line 572; and
d(x) is the slope of line 570.

Scheduling module 320 employs the crossover point to set one or more values for the composite bandwidth schedule in the selected interval (step 564).

FIG. 19 is a flowchart describing one embodiment of a process for setting values for the composite bandwidth schedule within a selected interval (step 564, FIG. 17). Scheduling module 320 determines whether the integer portion of the crossover occurs at the start point of the interval−meaning Q equals 0 (step 580). If this is the case, scheduling module 300 determines whether the interval is a single unit long−meaning w equals 1 unit of the time measurement being employed (step 582). In the case of a single unit interval, scheduling module 320 sets a single value for the composite bandwidth within the selected interval (step 586). In one embodiment, this value is set as follows:
For x<=t<x+1: cb(t) equals the slope of the data demand line with the greatest value at the end of the interval less the remainder value RM.

If the interval is not a single unit (step 582), scheduling module 320 sets two values for the composite bandwidth schedule within the selected interval (step 590). In one embodiment, these values are set as follows:
For x<=t<x+1: cb(t) equals the slope of the data demand line with the greatest value at the end of the interval less the remainder value RM; and
For x+1<=t<x+w: cb(t) equals the slope of the data demand line with the greatest value at the end of the interval.

If the integer portion of the crossover does not occur at the starting point of the interval (step 580), scheduling module 320 determines whether the integer portion of the crossover occurs at the end point of the selected interval-meaning Q>0 and Q+1=w (step 584). If this is the case, scheduling module 320 sets two values for the composite bandwidth schedule within the interval (step 588). In one embodiment, these values are set as follows:
For x<=t<x+Q: cb(t) equals the slope of the data demand line with the lowest value at the end of the interval; and
For x+Q<=t<x+w: cb(t) equals the slope of the data demand line with the greatest value at the end of the interval less the remainder value RM.

If the integer portion of the crossover is not an end point (step 584), scheduling module 320 sets three values for the composite bandwidth schedule in the selected interval (step 600). In one embodiment, these values are set as follows:
For x<=t<x+Q: cb(t) equals the slope of the data demand line with the lowest value at the end of the interval;
For x+Q<=t<x+Q+1: cb(t) equals the slope of the data demand line with the greatest value at the end of the interval less the remainder value RM; and
For x+Q+1<=t<x+w: cb(t) equals the slope of the data demand line with the greatest value at the end of the interval.

By applying the above-described operations, the data demanded by the composite bandwidth schedule during the selected interval equals the total data required for servicing the individual bandwidth schedules, c(t) and d(t). In one embodiment, this results in the data demanded by the composite bandwidth schedule from the beginning of time through the selected interval to equal the largest cumulative amount of data specified by one of the individual bandwidth schedules through the selected interval. In mathematical terms, for the case where a crossover exists between C(t) and D(t) within the selected interval and D(t) is larger than C(t) at the end of the interval:

$${\int }_{x}^{x + w} c b ( t ) ⅆ t = {\int }_{x}^{x + w} d ( t ) ⅆ t - {\int }_{x}^{x + w} c ( t ) ⅆ t$$

FIG. 20 is a graph showing one example of values set for the composite bandwidth schedule in the selected interval in step 600 (FIG. 19) using data demand lines 570 and 572 in FIG. 18. In this example, c_oldint=80, d_{oldint=}72, x=0, w=5, c(0)=1, and d(0)=5. This results in the following:
Q=INT[(80−72)/(5−1)]=2
RM=(80−72)−2* (5−1)=0
For 0<=t<2: cb(t)=1;
For 2<=t<3: cb(t)=5−0=5; and
For 3<=t<5: cb(t)=5.

Composite bandwidth schedule 574 in FIG. 20 reflects the above-listed value settings in the selected interval.

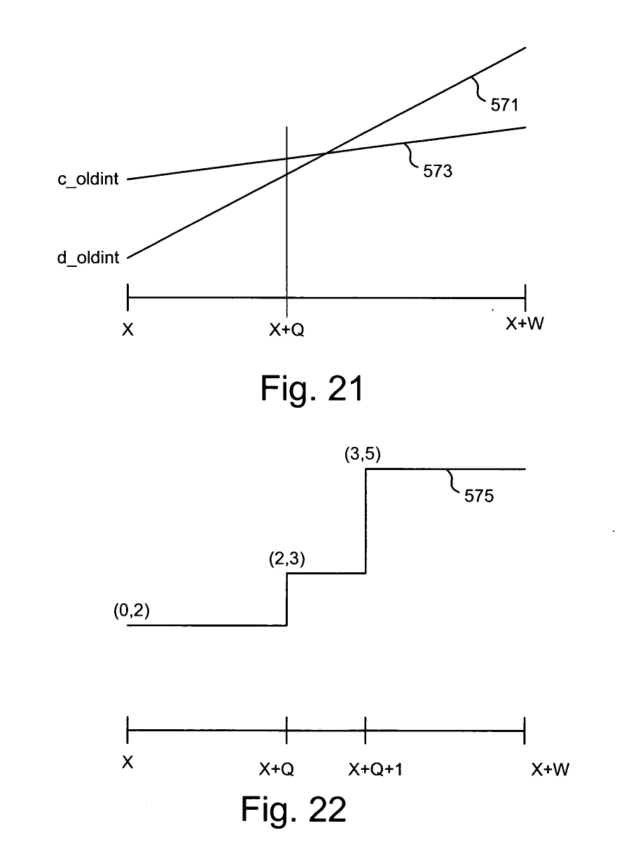

FIG. 21 illustrates a non-integer data demand crossover point occurring within a selected interval spanning from time x to time x+w. Line 571 represents D(t) and line 573 represents C(t). In the selected interval, D(t) and C(t) cross at time x+Q+(RM/(d(x)−c(x)).

FIG. 22 is a graph showing one example of values set for the composite bandwidth schedule in the selected interval in step 600 (FIG. 19) using data demand lines 571 and 573 in FIG. 21. In this example, c_oldint=80, d_oldint=72, x=0, w=5, c(0)=2, and d(0)=5. This results in the following:
Q=INT[(80−72)/(5−2)]=2
RM=(80−72)−2*(5−2)=2
For 0<=t<2: cb(t)=2;
For 2<=t<3: cb(t)=5−2=3; and
For 3<=t<5: cb(t)=5.

FIG. 23 is a flowchart describing one embodiment of a process for determining whether sufficient transmission bandwidth exists at a data source (sender or intermediary) to satisfy a scheduling request (step 472, FIG. 9). In one embodiment, this includes the generation of a send bandwidth schedule r(t) that satisfies the demands of a bandwidth schedule s(t) associated with the scheduling request. In one implementation, as described above, the scheduling request bandwidth schedule s(t) is a composite bandwidth schedule cb(t).

Scheduling module 320 in the data source considers bandwidth schedule s(t) and constraints on the ability of the data source to provide data to the requesting node. One example of such a constraint is limited availability of transmission bandwidth. In one implementation, the constraints can be expressed as a constraint bandwidth schedule cn(t). In this embodiment, bandwidth schedules are generated as step functions. In alternate embodiments, bandwidth schedules can have different formats.

Scheduling module 320 selects an interval of time where bandwidth schedules s(t) and cn(t) have constant values (step 630). In one embodiment, scheduling module 320 begins selecting intervals from the time at the end of scheduling request bandwidth schedule s(t)—referred to herein as s_end. The selected interval begins at time x and extends for all time before time x+w—meaning the selected interval is expressed as x<=t<x+w. In one implementation, scheduling module 320 determines the values for send bandwidth schedule r(t) in the time period x+w<=t<s_end before selecting the interval x<=t<x+w.

Scheduling module 320 sets one or more values for the send bandwidth schedule r(t) in the selected interval (step 632). Scheduling module 300 determines whether any intervals remain unselected (step 634). In one implementation, intervals remain unselected as long the requirements of s(t) have not yet been satisfied and the constraint bandwidth schedule is non zero for some time not yet selected.

If any intervals remain unselected, scheduling module 320 selects a new interval (step 630) and determines one or more send bandwidth values for the interval (step 632). Otherwise, scheduling module 320 determines whether the send bandwidth schedule meets the requirements of the scheduling request (step 636). In one example, constraint bandwidth schedule cn(t) may prevent the send bandwidth schedule r(t) from satisfying scheduling request bandwidth schedule s(t). If the scheduling request requirements are met (step 636), sufficient bandwidth exists and scheduling module 320 reserves transmission bandwidth (step 474, FIG. 9) corresponding to send bandwidth schedule r(t). Otherwise, scheduling module 320 reports that there is insufficient transmission bandwidth.

FIG. 24 is a flowchart describing one embodiment of a process for setting send bandwidth schedule values within an interval (step 632, FIG. 23). The process shown in FIG. 24 is based on meeting the following conditions: (1) the final send bandwidth schedule r(t) is always less than or equal to constraint bandwidth schedule cn(t); (2) data provided according to the final send bandwidth schedule r(t) is always greater than or equal to data required by scheduling request bandwidth schedule s(t); and (3) the final send bandwidth schedule r(t) is the latest send bandwidth schedule possible, subject to conditions (1) and (2).

For the selected interval, scheduling module 320 initially sets send bandwidth schedule r(t) equal to the constraint bandwidth schedule cn(t) (step 640). Scheduling module 320 then determines whether the value for constraint bandwidth schedule cn(t) is less than or equal to scheduling request bandwidth schedule s(t) within the selected interval (step 641). If so, send bandwidth schedule r(t) remains set to the value of constraint bandwidth schedule cn(t) in the selected interval. Otherwise, scheduling module 320 determines whether a crossover occurs in the selected interval (642).

A crossover may occur within the selected interval between the values R(t) and S(t), as described below:

$$R ( t ) = {\int }_{t}^{x + w} c n ( v ) ⅆ v + {\int }_{x + w}^{s\_end} r ( v ) ⅆ v$$

(representing the accumulated data specified by send bandwidth schedule r(t) as initially set, in a range spanning the beginning of the selected interval through s_end); and

$$S ( t ) = {\int }_{t}^{s\_end} s ( v ) ⅆ v$$
(representing the accumulated data specified by scheduling request bandwidth schedule s(t) in a range spanning the beginning of the selected interval through s_end).

A crossover occurs when the lines defined by R(t) and S(t) cross. When a crossover does not occur within the selected interval, scheduling module 320 sets send bandwidth schedule r(t) to the value of constraint bandwidth schedule cn(t) for the entire interval (step 648).

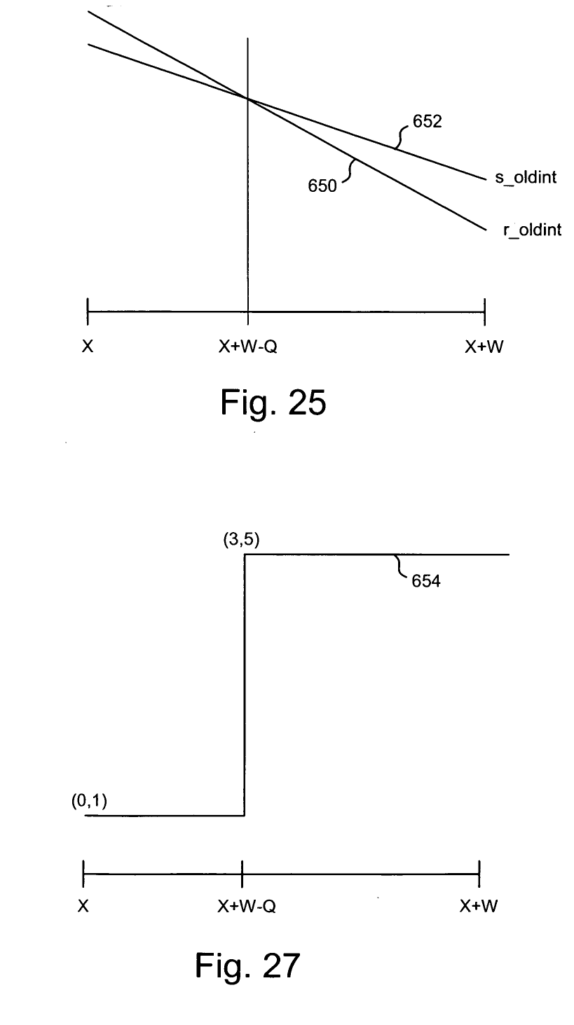

When a crossover does occur within a selected interval, scheduling module 320 identifies the time in the interval when the crossover point occurs (step 644). FIG. 25 illustrates an accumulated data crossover point occurring within a selected interval (x<=t<x+w). Line 650 represents the R(t) that results from initially setting r(t) to cn(t) in step 640 (FIG. 24). Line 652 represents S(t). In the selected interval, R(t) and S(t) cross at time x+w−Q, where Q is an integer. Alternatively, a crossover may occur at a non-integer point in time.

In one embodiment, scheduling module 300 identifies the time of the crossover point as follows:
Q=INT[(s_oldint−r_oldint)/(cn(x)−s(x))]; and
RM=(s_oldint−r_oldint)−Q*(cn(x)−s(x))
Wherein:
Q is the integer crossover point;
RM is the remainder from the division that produced Q, where t=x+w−Q−(RM/(s_oldint−r_oldint)) is the crossing point of R(t) and S(t) within the selected interval;

$$s\_oldint = {\int }_{x + w}^{s\_end} s ( t ) ⅆ t$$
(representing the y-intercept value for line 652);

$$r\_oldint = {\int }_{x + w}^{s\_end} r ( t ) ⅆ t$$
(representing the y-intercept value for line 650);
x is the starting time of the selected interval;
w is the time period of the selected interval;
−cn(x) is the slope of line 650; and
−s(x) is the slope of line 652.

Scheduling module 320 employs the crossover point to set one or more final values for send bandwidth schedule r(t) in the selected interval (step 646, FIG. 24).

FIG. 26 is a flowchart describing one embodiment of a process for setting final values for send bandwidth schedule r(t) within a selected interval (step 646, FIG. 24). Scheduling module 320 determines whether the integer portion of the crossover occurs at the end point of the interval−meaning Q equals 0 (step 660). If this is the case, scheduling module 320 determines whether the interval is a single unit long−meaning w equals 1 unit of the time measurement being employed (step 662). In the case of a single unit interval, scheduling module 320 sets a single value for send bandwidth schedule r(t) within the selected interval (step 666). In one embodiment, this value is set as follows:
For x<=t<x+w: r(t) equals the sum of the absolute value of the slope of accumulated data line S(t) and the remainder value RM−meaning r(t)=s(x)+RM.

If the interval is not a single unit (step 662), scheduling module 320 sets two values for send bandwidth schedule r(t) within the selected interval (step 668). In one embodiment, these values are set as follows:
For x<=t<x+w−1: r(t) equals the absolute value of the slope of accumulated data line S(t) ¾ meaning r(t)=s(x); and
For x+w−1<=t<x+w: r(t) equals the sum of the absolute value of the slope of accumulated data line S(t) and the remainder value RM−meaning r(t)=s(x)+RM.

If the integer portion of the crossover does not occur at the end point of the interval (step 660), scheduling module 320 determines whether the integer portion of the crossover occurs at the start point of the selected interval-meaning Q>0 and Q+1=w (step 664). If this is the case, scheduling module 320 sets two values for send bandwidth schedule r(t) within the selected interval (step 670). In one embodiment, these values are set as follows:
For x<=t<x+1: r(t) equals the sum of the absolute value of the slope of accumulated data line S(t) and the remainder value RM−meaning r(t)=s(x)+RM; and
For x+1<=t<x+w: r(t) equals the constraint bandwidth schedule-meaning r(t)=cn(x).

If the integer portion of the crossover is not a start point (step 664), scheduling module 320 sets three values for send bandwidth schedule r(t) in the selected interval (step 670). In one embodiment, these values are set as follows:
For x<=t<x+w−Q−1: r(t) equals the absolute value of the slope of accumulated data line S(t)−meaning r(t)=s(x);
For x+w−Q−1<=t<x+w−Q: r(t) equals the sum of the absolute value of the slope of accumulated data line S(t) and the remainder value RM−meaning r(t)=s(x)+RM; and
For x+w−Q<=t<x+w: r(t) equals the constraint bandwidth schedule−meaning r(t)=cn(x).

By applying the above-described operations, send bandwidth schedule r(t) provides data that satisfies scheduling request bandwidth schedule s(t) as late as possible. In one embodiment, where cn(t)>s(t) for a selected interval, the above-described operations result in the cumulative amount of data specified by r(t) from s_end through the start of the selected interval (x) to equal the cumulative amount of data specified by s(t) from s_end through the start of the selected interval (x).

FIG. 27 is a graph showing one example of values set for the send bandwidth schedule in the selected interval in step 672 (FIG. 26) using accumulated data lines 652 and 650 in FIG. 25. In this example, s_oldint=80, r_oldint=72, x=0, w=5, s(x)=1, and cn(x)=5. This results in the following:
Q=INT[(80−72)/(5−1)]=2
RM=(80−72)−2*(5−1)=0
For 0<=t<2: r(t)=1;
For 2<=t<3: r(t)=1+0=1; and
For 3<=t<5: r(t)=5.

Send bandwidth schedule 654 in FIG. 27 reflects the above-listed value settings in the selected interval.

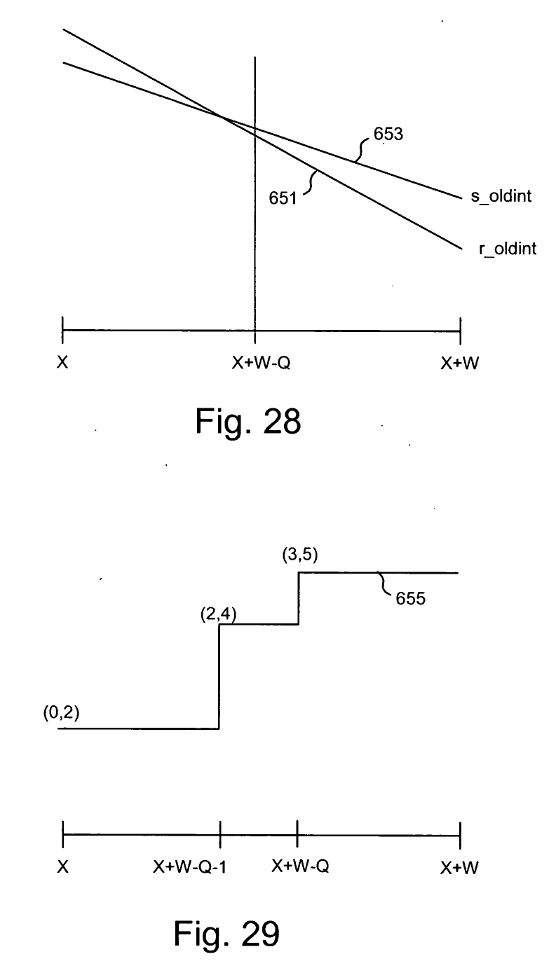

FIG. 28 illustrates a non-integer data demand crossover point occurring within a selected interval spanning from time x to time x+w. Line 653 represents S(t) and line 651 represents R(t) with the initial setting of r(t) to cn(t) in the selected interval. In the selected interval, S(t) and R(t) cross at time x+w−Q−(RM/(cn(x)−s(x)).

FIG. 29 is a graph showing one example of values set for send bandwidth schedule r(t) in the selected interval in step 672 (FIG. 26) using accumulated data lines 653 and 651 in FIG. 28. In this example, s_oldint=80, r_oldint=72, x=0, w=5, cn(x)=5, and s(x)=2. This results in the following:
Q=INT[(80−72)/(5−2)]=2
RM=(80−72)−2*(5−2)=2
For 0<=t<2: r(t)=2;
For 2<=t<3: r(t)=2+2=4; and
For 3<=t<5: r(t)=5.

In the above discussion of bandwidth schedules, if there are resource reservations per the resource management algorithm of the present invention for receive bandwidth on C and/or D, then these will have been taken into account before the available receive bandwidth is computed and sent on to B. Similarly, if node B already has the requested data, then for each of the downstream requests, it will compute whether or not it has adequate transmit bandwidth, subject to its own resource reservations for transmit bandwidth, and also less than or equal to the offered receive bandwidth, in order to accomplish the transfer. If the answer is yes, the request will be granted. If the answer is no, the request will be denied.

If node B does not already have the requested data, it first figures out as in the paragraph above, when and how it would transmit the data to the requestors. Assuming this is possible, node B then tries to obtain the required data from upstream nodes early enough so that it can achieve all the transmit schedules it has just computed. When node B requests data from an upstream node, it must offer receive bandwidth to the upstream node. The offered receive bandwidth must be “early enough” to satisfy the “composite schedule” of all the downstream transmits, and it must be consistent with the resource reservations per the present invention on node B for receive bandwidth.

Every time resources are allocated or made available to another node, they must be consistent with the local resource reservations per the resource management algorithm.

Some embodiments of the present invention employ forward and reverse proxies. A forward proxy is recognized by a node that desires data from a data source as a preferable alternate source for the data. If the node has a forward proxy for desired data, the node first attempts to retrieve the data from the forward proxy. A reverse proxy is identified by a data source in response to a scheduling request as an alternate source for requested data. After receiving the reverse proxy, the requesting node attempts to retrieve the requested data from the reverse proxy instead of the original data source. A node maintains a redirection table that correlates forward and reverse proxies to data sources, effectively converting reverse proxies into forward proxies for later use. Using the redirection table avoids the need to receive the same reverse proxy multiple times from a data source.

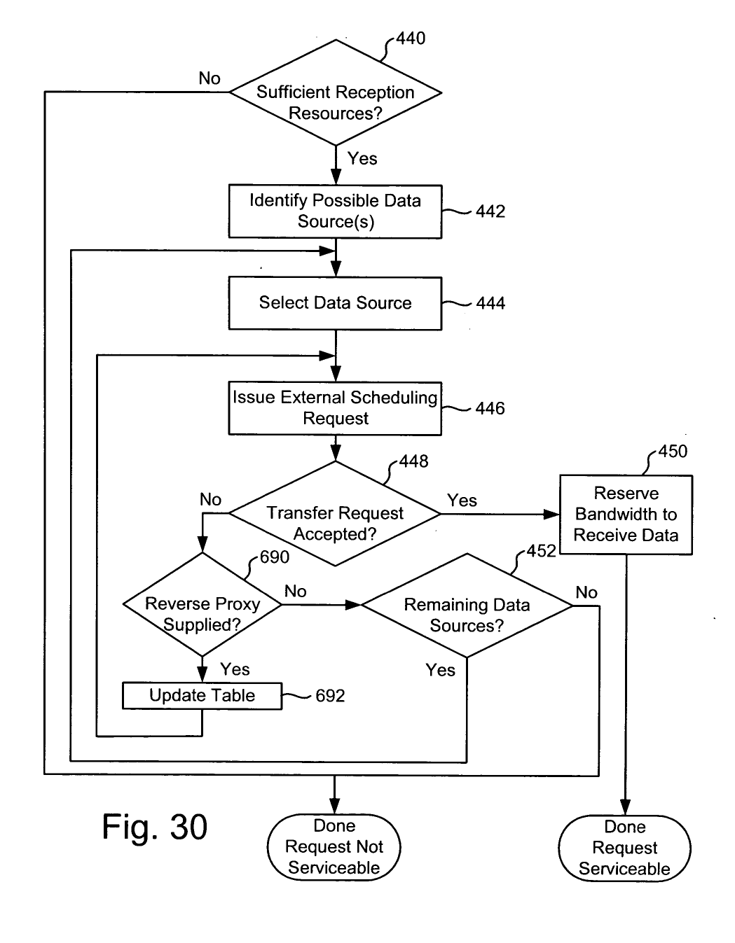

FIG. 30 is a flowchart describing an alternate embodiment of a process for determining whether a data transfer request is serviceable, using proxies. The steps with the same numbers used in FIGS. 8 and 13 operate as described above with reference to FIGS. 8 and 13. In further embodiments, the process shown in FIG. 30 also includes the steps shown in FIG. 13 for generating a composite bandwidth schedule for multiple requests.

In order to handle proxies, the process in FIG. 30 includes the step of determining whether a reverse proxy is supplied (step 690) when an external scheduling is denied (step 448). If a reverse proxy is not supplied, transfer module 300 determines whether there are any remaining data sources (step 452). Otherwise, transfer module 300 updates the node's redirection table with the reverse proxy (step 692) and issues a new scheduling request to the reverse proxy for the desired data (step 446). In one embodiment, the redirection table update (step 692) includes listing the reverse proxy as a forward proxy for the node that returned the reverse proxy.

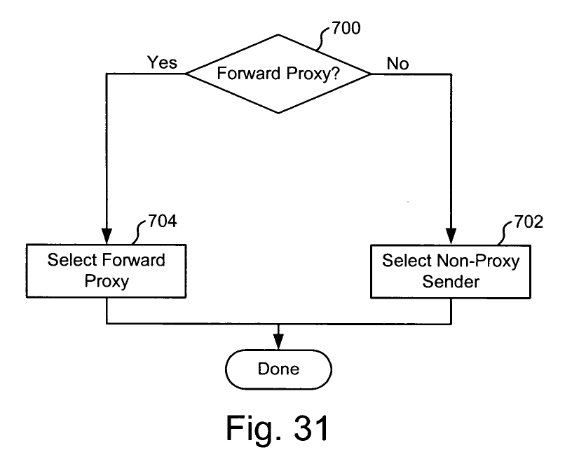

FIG. 31 is a flowchart describing one embodiment of a process for selecting a data source (step 444, FIGS. 8, 13, and 30), using proxies. Transfer module 300 determines whether there are any forward proxies associated with the desired data that have not yet been selected (step 700). If so, transfer module 300 selects one of the forward proxies as the desired data source (step 704). In one embodiment, transfer module 300 employs the redirection table to identify forward proxies. In one such embodiment, the redirection table identifies a data source and any forward proxies associated with the data source for the requested data. If no forward proxies are found, transfer module 300 selects a non-proxy data source as the desired sender (step 702).

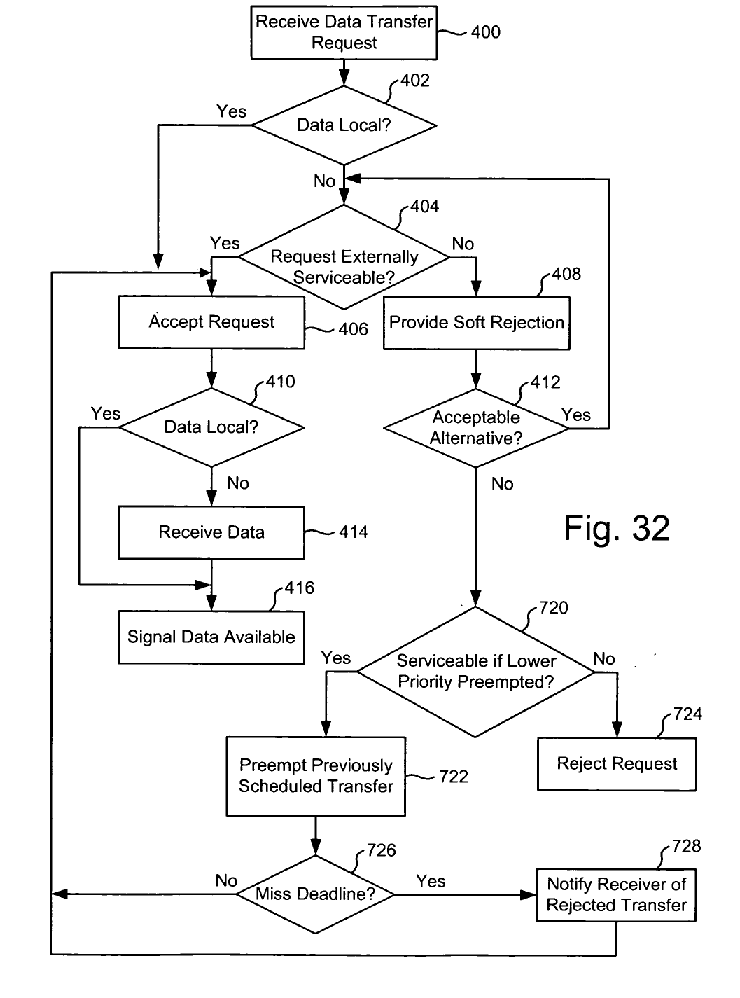

FIG. 32 is a flowchart describing an alternate embodiment of a process for servicing data transfer requests when preemption is allowed. The steps with the same numbers used in FIG. 6 operate as described above with reference to FIG. 6. Once a data request has been rendered unserviceable (step 412), transfer module 300 determines whether the request could be serviced by preempting a transfer from a lower priority request (step 720).

Priority module 370 (FIG. 5A) is included in embodiments of transfer module 300 that support multiple priority levels. In one embodiment, priority module 370 uses the following information to determine whether preemption is warranted (step 720): (1) information about a request (requesting node, source node, file size, deadline), (2) information about levels of service available at the requesting node and the source node, (3) additional information about cost of bandwidth, and (4) a requested priority level for the data transfer. In further embodiments, additional or alternate information can be employed.

If preemption of a lower priority transfer will not allow a request to be serviced (step 720), the request is finally rejected (step 724). Otherwise, transfer module 300 preempts a previously scheduled transfer so the current request can be serviced (step 722). In one embodiment, preemption module 502 (FIG. 10) finds lower priority requests that have been accepted and whose allocated resources are relevant to the current higher priority request. The current request then utilizes the bandwidth and other resources formerly allocated to the lower priority request. In one implementation, a preemption results in the previously scheduled transfer being cancelled. In alternate implementations, the previously scheduled transfer is rescheduled to a later time.

Transfer module 300 determines whether the preemption causes a previously accepted request to miss a deadline (step 726). Fox example, the preemption may cause a preempted data transfer to fall outside a specified window of time. If so, transfer module 300 notifies the data recipient of the delay (step 728). In either case, transfer module 300 accepts the higher priority data transfer request (step 406) and proceeds as described above with reference to FIG. 6.

In further embodiments, transfer module 300 instructs receiver scheduling module 320 to poll source nodes of accepted transfers to update their status. Source node scheduling module 320 replies with an OK message (no change in status), a DELAYED message (transfer delayed by some time), or a CANCELED message.

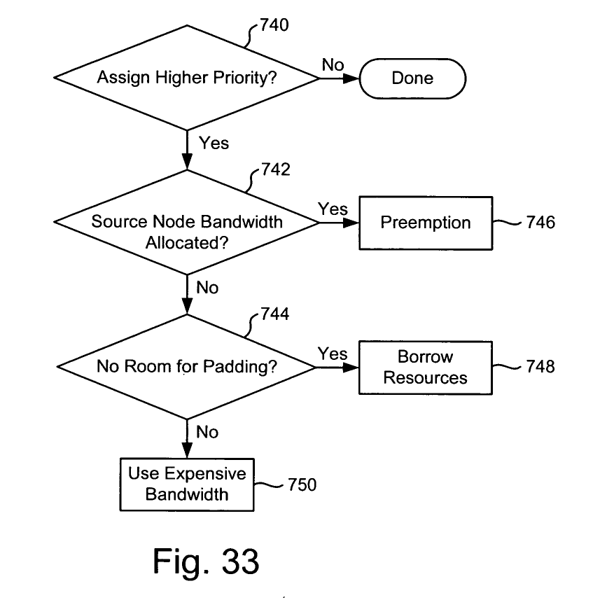

FIG. 33 is a flowchart describing one embodiment of a process for servicing data transfer requests in an environment that supports multiple priority levels. All or some of this process may be incorporated in step 404 and/or step 720 (FIG. 32) in further embodiments of the present invention. Priority module 370 (FIG. 5A) determines whether the current request is assigned a higher priority than any of the previous requests (step 740). In one embodiment, transfer module 300 queries a user to determine whether the current request's priority should be increased to allow for preemption. For example, priority module 370 gives a user requesting a data transfer an option of paying a higher price to assign a higher priority to the transfer. If the user accepts this option, the request has a higher priority and has a greater chance of being accepted.

If the assigned priority of the current request is not higher than any of the scheduled transfers (step 740), preemption is not available. Otherwise, priority module 370 determines whether the current request was rejected because all transmit bandwidth at the source node was already allocated (step 742). If so, preemption module 502 preempts one or more previously accepted transfers from the source node (step 746). If not, priority module 370 determines whether the current request was rejected because there was no room for padding (step 744). If so, preemption module 502 borrows resources from other transfers at the time of execution in order to meet the deadline. If not, preemption module 502 employs expensive bandwidth that is available to requests with the priority level of the current request (step 750). In some instances, the available bandwidth may still be insufficient.

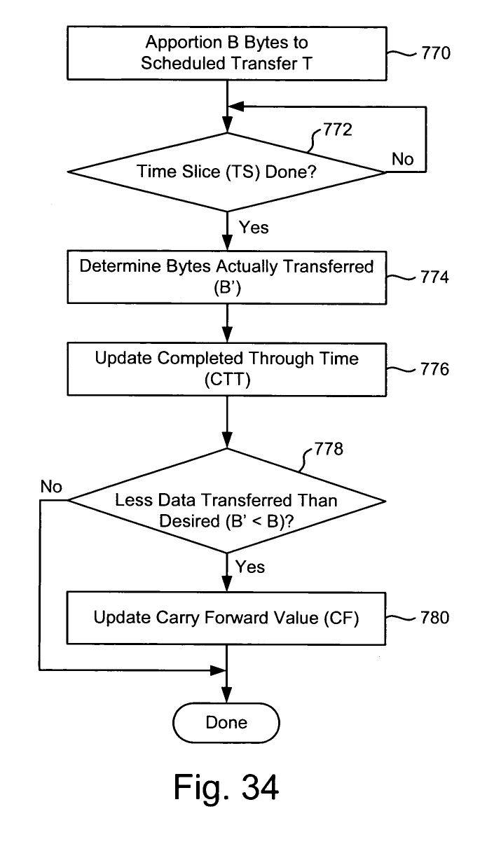

FIG. 34 is a flowchart describing one embodiment of a process for tracking the use of allocated bandwidth. When scheduling module 320 uses explicit scheduling routine 504, the apportionment of available bandwidth to a scheduled transfer depends upon the details of the above-described bandwidth schedules. In one embodiment, a completed through time (CTT) is associated with a scheduled transfer T. CTT serves as a pointer into the bandwidth schedule transfer T.

For a time slice of length TS, execution module 330 apportions B bytes to transfer T (step 770), where B is the integral of the bandwidth schedule from CTT to CTT+TS. After detecting the end of time slice TS (step 772), execution module 340 determines the number of bytes actually transferred, namely B′ (step 774). Execution module 340 then updates CTT to a new value, namely CTT′ (step 776), where the integral from CTT to CTT′ is B′.

At the end of time slice TS, execution module 340 determines whether the B′ amount of data actually transferred is less than the scheduled B amount of data (step 778). If so, execution module 340 updates a carry forward value CF to a new value CF′, where CF′=CF+B−B′. Otherwise, CF is not updated. The carry forward value keeps track of how many scheduled bytes have not been transferred.

Any bandwidth not apportioned to other scheduled transfers can be used to reduce the carry forward. Execution module 340 also keeps track of which scheduled transfers have been started or aborted. Transfers may not start as scheduled either because space is not available at a receiver or because the data is not available at a sender. Bandwidth planned for use in other transfers that have not started or been aborted is also available for apportionment to reduce the carry forward.

As seen from FIG. 34, execution module 340 is involved in carrying out a node's scheduled transfers. In one embodiment, every instance of transfer module 300 includes execution module 340, which uses information stored at each node to manage data transfers. This information includes a list of accepted node-to-node transfer requests, as well as information about resource reservations committed by scheduling module 320.

Execution module 340 is responsible for transferring data at the scheduled rates. Given a set of accepted requests and a time interval, execution module 340 selects the data and data rates to employ during the time interval. In one embodiment, execution module 340 uses methods as disclosed in the U.S. Patent application Ser. No. 09/853,816, entitled “System and Method for Controlling Data Transfer Rates on a Network,” previously incorporated by reference.

The operation of execution module 340 is responsive to the operation of scheduling module 320. For example, if scheduling module 320 constructs explicit schedules, execution module 340 attempts to carry out the scheduled data transfers as close as possible to the schedules. Alternatively, execution module 340 performs data transfers as early as possible, including ahead of schedule. If scheduling module 320 uses feasibility test module 502 to accept data transfer request, execution module 340 uses the results of those tests to prioritize the accepted requests.

As shown in FIG. 34, execution module 340 operates in discrete time slice intervals of length TS. During any time slice, execution module 340 determines how much data from each pending request should be transferred from a sender to a receiver. Execution module 340 determines the rate at which the transfer should occur by dividing the amount of data to be sent by the length of the time slice TS. If scheduling module 320 uses explicit scheduling routine 504, there are a number of scheduled transfers planned to be in progress during any time slice. There may also be transfers that were scheduled to complete before the current time slice, but which are running behind schedule. In further embodiments, there may be a number of dynamic requests receiving service, and a number of dynamic requests pending.

Execution module 340 on each sender apportions the available transmit bandwidth among all of these competing transfers. In some implementations, each sender attempts to send the amount of data for each transfer determined by this apportionment. Similarly, execution module 340 on each receiver may apportion the available receive bandwidth among all the competing transfers. In some implementations, receivers control data transfer rates. In these implementations, the desired data transfer rates are set based on the amount of data apportioned to each receiver by execution module 340 and the length of the time slice TS.

In other implementations, both a sender and receiver have some control over the transfer. In these implementations, the sender attempts to send the amount of data apportioned to each transfer by its execution module 340. The actual amount of data that can be sent, however, may be restricted either by rate control at a receiver or by explicit messages from the receiver giving an upper bound on how much data a receiver will accept from each transfer.

Execution module 340 uses a dynamic request protocol to execute data transfers ahead of schedule. One embodiment of the dynamic request protocol has the following four message types:
DREQ(id, start, rlimit, Dt);
DGR(id, rlimit);
DEND_RCV(id, size); and
DEND_XMIT(id, size, Dt).

DREQ(id, start, rlimit, Dt) is a message from a receiver to a sender calling for the sender to deliver as much as possible of a scheduled transfer identified by id. The DREQ specifies for the delivery to be between times start and start+Dt at a rate less than or equal to rlimit. The receiver reserves rlimit bandwidth during the time interval from start to start+Dt for use by this DREQ. The product of the reserved bandwidth, rlimit, and the time interval, Dt, must be greater than or equal to a minimum data size BLOCK. The value of start is optionally restricted to values between the current time and a fixed amount of time in the future. The DREQ expires if the receiver does not get a data or message response from the sender by time start+Dt.

DGR(id, rlimit) is a message from a sender to a receiver to acknowledge a DREQ message. DGR notifies the receiver that the sender intends to transfer the requested data at a rate that is less than or equal to rlimit. The value of rlimit used in the DGR command must be less than or equal to the limit of the corresponding DREQ.

DEND_RCV(id, size) is a message from a receiver to a sender to inform the sender to stop sending data requested by a DREQ message with the same id. DEND also indicates that the receiver has received size bytes.

DEND_XMIT(id, size, Dt) is a message from a sender to a receiver to signal that the sender has stopped sending data requested by a DREQ message with the same id, and that size bytes have been sent. The message also instructs the receiver not to make another DREQ request to the sender until Dt time has passed. In one implementation, the message DEND_XMIT(id, 0, Dt) is used as a negative acknowledgment of a DREQ.

A transfer in progress and initiated by a DREQ message cannot be preempted by another DREQ message in the middle of a transmission of the minimum data size BLOCK. Resource reservations for data transfers are canceled when the scheduled data transfers are completed prior to their scheduled transfer time. The reservation cancellation is done each time the transfer of a BLOCK of data is completed.

If a receiver has excess receive bandwidth available, the receiver can send a DREQ message to a sender associated with a scheduled transfer that is not in progress. Transfers not in progress and with the earliest start time are given the highest priority. In systems that include time varying cost functions for bandwidth, the highest priority transfer not in progress is optionally the one for which moving bandwidth consumption from the scheduled time to the present will provide the greatest cost savings. The receiver does not send a DREQ message unless it has space available to hold the result of the DREQ message until its expected use (i.e. the deadline of the scheduled transfer).

If a sender has transmit bandwidth available, and has received several DREQ messages requesting data transfer bandwidth, the highest priority DREQ message corresponds to the scheduled transfer that has the earliest start time. The priority of DREQ messages for transfers to intermediate local storages is optionally higher than direct transfers. Completing these transfers early will enable the completion of other data transfers from an intermediary in response to DREQ messages. While sending the first BLOCK of data for some DREQ, the sender updates its transmit schedule and then re-computes the priorities of all pending DREQ's. Similarly, a receiver can update its receive schedule and recompute the priorities of all scheduled transfers not in progress.

In one embodiment of the present invention, transfer module 300 accounts for transmission rate variations when reserving resources. Slack module 350 (FIG. 5A) reserves resources at a node in a data transfer path. The reservation of resources by slack module 350 may be separate and independent from the reservation of resources according to the resource management algorithm described above. It is understood that the reservation of resources otherwise performed by the slack module may be incorporated into the resource management algorithm. Slack module 350 reserves resource based on the total available resources on each node involved in a data transfer, as determined by the resource management algorithm , and historical information about resource demand as a function of time. The amount of excess resources reserved is optionally based on statistical models of the historical information.

In one embodiment slack module 350 reserves a fixed percentage of all bandwidth resources (e.g. 20%). In an alternative embodiment, slack module 350 reserves a larger fraction of bandwidth resources at times when transfers have historically run behind schedule (e.g., between 2 and 5 PM on weekdays). The reserved fraction of bandwidth is optionally spread uniformly throughout each hour, or alternatively concentrated in small time intervals (e.g., 1 minute out of each 5 minute time period).

In one implementation, transfer module 300 further guards against transmission rate variations by padding bandwidth reserved for data transfers. Padding module 360 (FIG. 5A) in transfer module 300 determines an amount of padding time P. Transfer module 300 adds padding time P to an estimated data transfer time before scheduling module 320 qualifies a requested data transfer as acceptable. Padding time P is chosen such that the probability of completing the transfer before a deadline is above a specified value. In one embodiment, padding module 360 determines padding time based on the identities of the sender and receiver, a size of the data to be transferred, a maximum bandwidth expected for the transfer, and historical information about achieved transfer rates.

In one embodiment of padding module 360, P is set as follows:
P=MAX[MIN_PAD, PAD_FRACTION*ST]
Wherein:
MAX [ ] is a function yielding the maximum value within the brackets;
ST is the scheduled transfer time; and
MIN_PAD and PAD_FRACTION are constants.

In one implementation MIN_PAD is 15 minutes, and PAD_FRACTION is 0.25. In alternative embodiments, MIN_PAD and PAD_FRACTION are varied as functions of time of day, sender-receiver pairs, or historical data. For example, when a scheduled transfer spans a 2 PM-5 PM interval, MIN_PAD may be increased by 30 minutes.

In another embodiment, P is set as follows:
P=ABS_PAD+FRAC_PAD_TIME
Wherein:
ABS_PAD is a fixed time (e.g., 5 seconds);
FRAC_PAD_TIME is the time required to transfer B bytes;
B=PAD_FRACTION*SIZE; and
SIZE is the size of the requested data file.

In this embodiment, available bandwidth is taken into account when FRAC_PAD_TIME is computed from B.

In further embodiments, transfer module 300 employs error recovery module 380 (FIG. 5A) to manage recovery from transfer errors. If a network failure occurs, connections drop, data transfers halt, and/or schedule negotiations timeout. Error recovery module 380 maintains a persistent state at each node, and the node uses that state to restart after a failure. Error recovery module 380 also minimizes (1) the amount of extra data transferred in completing interrupted transfers and (2) the number of accepted requests that are canceled as a result of failures and timeouts.

In one implementation, data is stored in each node to facilitate restarting data transfers. Examples of this data includes data regarding requests accepted by scheduling module 320, resource allocation, the state of each transfer in progress, waiting lists 508 (if these are supported), and any state required to describe routing policies (e.g., proxy lists).

Error recovery module 380 maintains a persistent state in an incremental manner. For example, data stored by error recovery module 380 is updated each time one of the following events occurs: (1) a new request is accepted; (2) an old request is preempted or; (3) a DREQ transfers data of size BLOCK. The persistent state data is reduced at regular intervals by eliminating all requests and DREQs for transfers that have already been completed or have deadlines in the past.

In one embodiment, the persistent state for each sender includes the following: (1) a description of the allocated transmit bandwidth for each accepted request and (2) a summary of each transmission completed in response to a DREQ. The persistent state for each receiver includes the following: (1) a description of the allocated receive bandwidth and allocated space for each accepted request and (2) a summary of each data transfer completed in response to a DREQ.

Although many of the embodiments discussed above describe a distributed system, a centrally controlled system is within the scope of the invention. In one embodiment, a central control node, such as a server, includes transfer module 300. In the central control node, transfer module 300 evaluates each request for data transfers between nodes in communication network 100. Transfer module 300 in the central control node also manages the execution of scheduled data transfers and dynamic requests.

Transfer module 300 in the central control node periodically interrogates (polls) each node to ascertain the node's resources as given by the resource management algorithm, such as bandwidth and storage space. Transfer module 300 then uses this information to determine whether a data transfer request should be accepted or denied. In this embodiment, transfer module 300 in the central control node includes software required to schedule and execute data transfers. This allows the amount of software needed at the other nodes in communications network 100 to be smaller than in fully distributed embodiments. In another embodiment, multiple central control devices are implemented in communications network 100.

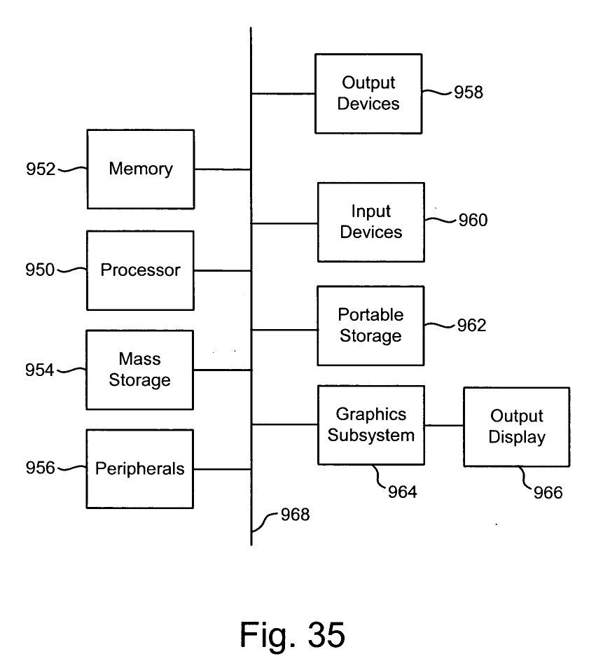

FIG. 35 illustrates a high level block diagram of a computer system that can be used for the components of the present invention. The computer system in FIG. 35 includes processor unit 950 and main memory 952. Processor unit 950 may contain a single microprocessor, or may contain a plurality of microprocessors for configuring the computer system as a multi processor system. Main memory 952 stores, in part, instructions and data for execution by processor unit 950. If the system of the present invention is wholly or partially implemented in software, main memory 952 can store the executable code when in operation. Main memory 952 may include banks of dynamic random access memory (DRAM) as well as high speed cache memory.

The system of FIG. 35 further includes mass storage device 954, peripheral device(s) 956, user input device(s) 960, portable storage medium drive(s) 962, graphics subsystem 964, and output display 966. For purposes of simplicity, the components shown in FIG. 35 are depicted as being connected via a single bus 968. However, the components may be connected through one or more data transport means. For example, processor unit 950 and main memory 952 may be connected via a local microprocessor bus, and the mass storage device 954, peripheral device(s) 956, portable storage medium drive(s) 962, and graphics subsystem 964 may be connected via one or more input/output (I/O) buses. Mass storage device 954, which may be implemented with a magnetic disk drive or an optical disk drive, is a non volatile storage device for storing data and instructions for use by processor unit 950. In one embodiment, mass storage device 954 stores the system software for implementing the present invention for purposes of loading to main memory 952.

Portable storage medium drive 962 operates in conjunction with a portable non volatile storage medium, such as a floppy disk, to input and output data and code to and from the computer system of FIG. 35. In one embodiment, the system software for implementing the present invention is stored on such a portable medium, and is input to the computer system via the portable storage medium drive 962. Peripheral device(s) 956 may include any type of computer support device, such as an input/output (I/O) interface, to add additional functionality to the computer system. For example, peripheral device(s) 956 may include a network interface for connecting the computer system to a network, a modem, a router, etc.

User input device(s) 960 provide a portion of a user interface. User input device(s) 960 may include an alpha-numeric keypad for inputting alpha-numeric and other information, or a pointing device, such as a mouse, a trackball, stylus, or cursor direction keys. In order to display textual and graphical information, the computer system of FIG. 35 includes graphics subsystem 964 and output display 966. Output display 966 may include a cathode ray tube (CRT) display, liquid crystal display (LCD) or other suitable display device. Graphics subsystem 964 receives textual and graphical information, and processes the information for output to display 966. Additionally, the system of FIG. 35 includes output devices 958. Examples of suitable output devices include speakers, printers, network interfaces, monitors, etc.

The components contained in the computer system of FIG. 35 are those typically found in computer systems suitable for use with the present invention, and are intended to represent a broad category of such computer components that are well known in the art. Thus, the computer system of FIG. 35 can be a personal computer, handheld computing device, Internet-enabled telephone, workstation, server, minicomputer, mainframe computer, or any other computing device. The computer can also include different bus configurations, networked platforms, multi-processor platforms, etc. Various operating systems can be used including Unix, Linux, Windows, Macintosh OS, Palm OS, and other suitable operating systems.

The foregoing detailed description of the invention has been presented for purposes of illustration and description. It is not intended to be exhaustive or to limit the invention to the precise form disclosed. Many modifications and variations are possible in light of the above teaching. The described embodiments were chosen in order to best explain the principles of the invention and its practical application to thereby enable others skilled in the art to best utilize the invention in various embodiments and with various modifications as are suited to the particular use contemplated. It is intended that the scope of the invention be defined by the claims appended hereto.

1. A method for managing resources at a node in a communications network, the method comprising the steps of:
(a) defining a pool of one or more classes at the node;
(b) reserving resources for the one or more classes in the pool of classes;
(c) processing a request for the resources made in one or more classes in the pool;
(d) determining restrictions on the request for resources based on the reservation of resources in the step (b); and
(e) granting or denying the request for resources based on the determination of restrictions on the request made in the step (d).

2. The method of claim 1, the step (b) of reserving resources comprising the step of arbitrarily allocating resources among the one or more classes.

3. The method of claim 1, the step (b) of reserving resources comprising the step of reserving resources for a first class of the one or more classes, reserving resources for a second class of the one or more classes, and reserving resources for the union of the first and second classes.

4. The method of claim 3, the step of reserving resources for the union of the first and second classes comprises the step of reserving a greater amount of resources than the sum of the resources reserved for the first and second classes.

5. The method of claim 3, the step of reserving resources for the union of the first and second classes comprises the step of reserving a lesser amount of resources than the sum of the resources reserved for the first and second classes.

6. The method of claim 1, the step (b) of reserving resources comprising the step of reserving transmit bandwidth.

7. The method of claim 1, the step (b) of reserving resources comprising the step of reserving receive bandwidth.

8. The method of claim 1, the step (b) of reserving resources comprising the step of reserving storage space.

9. The method of claim 1, the step (a) of defining a pool of one or more classes comprises the step of defining by an arbitrary logical OR of an arbitrary logical AND of properties that may be evaluated.

10. The method of claim 1, wherein the step (b) of reserving resources comprises the step of calculating the resources from known restrictions on requests belonging to the classes in the pool.

11. A method for managing resources at a node in a communications network after a grant of resource to a class of a pool of classes, the method comprising the steps of:
(a) subtracting the resources from the reservation representing the class;
(b) recomputing restrictions on all possible requests given the subtraction in the step (a);
(c) applying rules governing restrictions to the restrictions recomputed in the step (b);
(d) adjusting a restriction to the extent the restriction violates the rules governing restrictions; and
(e) recomputing the reservations if a restriction was adjusted in said step (d).

12. A method for managing resources at a node in a communications network after a grant of an amount A of a resource to a plurality of classes of a pool of classes, the method comprising the steps of:
(a) applying an inclusion-exclusion process to initially calculate the resources in the plurality of classes after the grant,
(b) recomputing restrictions on all possible requests given the subtraction in the step (a);
(c) applying rules governing restrictions to the restrictions recomputed in the step (b);
(d) adjusting a restriction to the extent the restriction violates the rules governing restrictions; and
(e) recomputing the reservations if a restriction was adjusted in said step (d).

13. A method of determining a restriction on a request for resources in defined m number of classes, i₁ through iₘ, from a pool of n number of classes, n greater than 0 and n greater than or equal to m, each class and combination of classes having reserved resources capable of being represented in an array res[k], k being an integer greater than 0 and less than 2ⁿ, and k having a binary expansion such that each bit in the binary expansion of k corresponds to a class in the pool, with the least significant bit corresponding to the first class, successively to the most significant bit corresponding to the n^{th} class, the restriction on the request for resources in the one or more defined classes allowing the determination of whether sufficient resources in the one or more defined classes are available to grant the request, the method comprising the steps of:
(a) determining the amount of resources in classes in which the request was not made, said step (a) including the step of:
(i) summing from 1 to (2ⁿ)−₁ all reservations res[k] having a value of k whose binary expansion has all zero bits i₁ through iₘ corresponding to classes i₁ through iₘ in which the request was made;
(b) subtracting the summation found in said step (a) from the total amount of resources available; and
(c) denying the request for resources if the request for resources is greater than the result found in said step (b) of subtracting the amount of resources in the classes in which the request was not made from the total amount of resources available; and
(d) granting the request for resources if the request for resources is less than or equal to the result found in said step (b) of subtracting the amount of resources in the classes in which the request was not made from the total amount of resources available.

14. The method of claim 13, wherein the restrictions on a request in m-1 number of classes is greater than or equal to the restrictions on a request in m number of classes.

15. One or more processor readable storage devices having processor readable code embodied on said processor readable storage devices, said processor readable code for programming one or more processors to perform a method of determining a restriction on a request for resources in defined classes i₁ through iₘ from a pool of n classes, n greater than 0 and n greater than or equal to m, each class and combination of classes having reserved resources capable of being represented in an array res[k], k being an integer greater than 0 and less than 2ⁿ, and k having a binary expansion such that each bit in the binary expansion of k corresponds to a class in the pool, with the least significant bit corresponding to the first class, successively to the most significant bit corresponding to the nth class, the restriction on the request for resources in the one or more defined classes allowing the determination of whether sufficient resources in the one or more defined classes are available to grant the request, the method comprising the steps of:
(a) determining the amount of resources in classes in which the request was not made, said step (a) including the step of:
(i) summing from 1 to (2ⁿ)−₁ all reservations res[k] having a value of k whose binary expansion has all zero bits i₁ through iₘ corresponding to classes i₁ through iₘ in which the request was made;
(b) subtracting the summation found in said step (a) from the total amount of resources available; and
(c) denying the request for resources if the request for resources is greater than the result found in said step (b) of subtracting the amount of resources in the classes in which the request was not made from the total amount of resources available; and
(d) granting the request for resources if the request for resources is less than or equal to the result found in said step (b) of subtracting the amount of resources in the classes in which the request was not made from the total amount of resources available.

16. A method of managing resources at a node in a computer network, comprising the steps of:
(a) determining a restriction on a request for resources in defined m number of classes, i₁ through iₘ, from a pool of n number of classes, n greater than 0 and n greater than or equal to m, each class and combination of classes having reserved resources capable of being represented in an array res[k], k being an integer greater than 0 and less than 2ⁿ, and k having a binary expansion such that each bit in the binary expansion of k corresponds to a class in the pool, with the least significant bit corresponding to the first class, successively to the most significant bit corresponding to the nth class, the restriction on the request for resources in the one or more defined classes allowing the determination of whether sufficient resources in the one or more defined classes are available to grant the request, the step (a) including the step of:
(i) determining the amount of resources in classes in which the request was not made, including the step of summing from 1 to (2ⁿ)−₁ all reservations res[k] having a value of k whose binary expansion has all zero bits i₁ through iₘ corresponding to classes i₁ through iₘ in which the request was made;
(b) subtracting the summation found in said step (a) from the total amount of resources available; and
(c) denying the request for resources if the request for resources is greater than the result found in said step (b) of subtracting the amount of resources in the classes in which the request was not made from the total amount of resources available; and
(d) granting the request for resources if the request for resources is less than or equal to the result found in said step (b) of subtracting the amount of resources in the classes in which the request was not made from the total amount of resources available.

17. The method of claim 16, wherein the restrictions on a request in m-1 number of classes is greater than or equal to the restrictions on a request in m number of classes.

18. The method of claim 16, after the step (d) of granting the request for resources, further comprising the steps:
(e) subtracting the resources from the reservation representing the class or classes in which the request was granted;
(f) recomputing restrictions on all possible requests given the subtraction in the step (e);
(g) applying rules governing restrictions to the restrictions recomputed in the step (f);
(h) adjusting a restriction to the extent the restriction violates the rules governing restrictions; and
(i) recomputing the reservations if a restriction was adjusted in said step (h).

19. The method of claim 18, the step (g) of applying rules governing restrictions including the step of applying the rule that a restriction on a request in m-1 number of classes must be greater than or equal to the restrictions on a request in m number of classes.

20. One or more processor readable storage devices having processor readable code embodied on said processor readable storage devices, said processor readable code for programming one or more processors to perform a method of managing resources at a node in a computer network, the method comprising the steps of:
(a) determining a restriction on a request for resources in defined m number of classes, i₁ through iₘ, from a pool of n number of classes, n greater than 0 and n greater than or equal to m, each class and combination of classes having reserved resources capable of being represented in an array res[k], k being an integer greater than 0 and less than 2ⁿ, and k having a binary expansion such that each bit in the binary expansion of k corresponds to a class in the pool, with the least significant bit corresponding to the first class, successively to the most significant bit corresponding to the n^{th} class, the restriction on the request for resources in the one or more defined classes allowing the determination of whether sufficient resources in the one or more defined classes are available to grant the request, the step (a) including the step of:
(i) determining the amount of resources in classes in which the request was not made, including the step of summing from 1 to (2ⁿ)−1 all reservations res[k] having a value of k whose binary expansion has all zero bits i₁ through iₘ corresponding to classes i₁ through iₘ in which the request was made;
(b) subtracting the summation found in said step (a) from the total amount of resources available; and
(c) denying the request for resources if the request for resources is greater than the result found in said step (b) of subtracting the amount of resources in the classes in which the request was not made from the total amount of resources available; and
(d) granting the request for resources if the request for resources is less than or equal to the result found in said step (b) of subtracting the amount of resources in the classes in which the request was not made from the total amount of resources available.

21. The one or more processor readable storage devices having processor readable code embodied on said processor readable storage devices, said processor readable code for programming one or more processors to perform the method of claim 20, wherein the restrictions on a request in m-1 number of classes is greater than or equal to the restrictions on a request in m number of classes.

22. The one or more processor readable storage devices having processor readable code embodied on said processor readable storage devices, said processor readable code for programming one or more processors to perform the method of claim 20, after the step (d) of granting the request for resources, further comprising the steps:
(e) subtracting the resources from the reservation representing the class or classes in which the request was granted;
(f) recomputing restrictions on all possible requests given the subtraction in the step (e);
(g) applying rules governing restrictions to the restrictions recomputed in the step (f);
(h) adjusting a restriction to the extent the restriction violates the rules governing restrictions; and
(i) recomputing the reservations if a restriction was adjusted in said step (h).

23. The one or more processor readable storage devices having processor readable code embodied on said processor readable storage devices, said processor readable code for programming one or more processors to perform the method of claim 22, the step (g) of applying rules governing restrictions including the step of applying the rule that a restriction on a request in m-1 number of classes must be greater than or equal to the restrictions on a request in m number of classes.
